(19) United States
(12) Patent Application Publication
(10) Pub. No.: US 2026/0082253 A1
(43) Pub. Date: Mar. 19, 2026

(54) METHODS, ARCHITECTURES, APPARATUSES, AND SYSTEMS FOR WIRELESS TRANSMIT/RECEIVE UNIT-ASSISTED SENSING IN THE PRESENCE OF ENVIRONMENTAL OBJECTS

(71) Applicant: InterDigital Patent Holdings, Inc., Wilmington, DE (US)

(72) Inventors: Heggo Mohammad, London (GB); Arman Shojaeifard, London (GB); Yasser Mestrah, London (GB); Ibrahim Hemadeh, Hemel Hempstead (GB); Fumihiro Hasegawa, Westmount (CA); Paul Marinier, Brossard (CA); Moon IL Lee, Melville, NY (US); Remun Koirala, London (GB); Ghyslain Pelletier, Montreal (CA)

(21) Appl. No.: 18/886,569

(22) Filed: Sep. 16, 2024

(51) Int. Cl. H04W 24/10; H04L 5/00; H04W 72/0453

(52) U.S. Cl. CPC H04W 24/10; H04L 5/0048; H04W 72/0453

(57) ABSTRACT

A method is performed by a wireless transmit/receive unit (WTRU) for a sensing task. The WTRU receives a configuration from a network. The configuration includes a configured measurement of a target object. The WTRU receives a reference signal and determines an observed measurement of the reference signal. By comparing the configured and observed measurements, the WTRU detects any mismatches and controls bandwidth aggregation accordingly. The method includes transmitting a report to the network indicating a mismatch detection event. The configuration may involve various triggers for adjusting bandwidth aggregation and measurement search windows. These triggers can be event-based, time-based, location-based, mobility-based, or quality of service-based. The method also involves comparing measurements at specific times or angles of arrival and adjusting based on preconfigured thresholds. Subsequent reference signals are used to confirm true match detection events, which can deactivate bandwidth aggregation. Details of the WTRU, the network, and related technologies are provided.

### TECHNICAL FIELD

The present disclosure is generally directed to the fields of communications, software and encoding, including, for example, to methods, architectures, apparatuses, systems related to a sensing task.

### BACKGROUND

User Equipment (UE) controls positioning measurements across multiple Downlink (DL) Positioning Reference Signal (PRS) frequency layers. The UE links DL PRS resource sets to ensure consistent parameters like Quasi Co-Location (QCL), periodicity, and subcarrier spacing. The UE can perform and report up to four aggregated measurements for DL Reference Signal Time Difference (RSTD) and UE reception-transmission (Rx-Tx) time differences, as requested by a network (NW). The UE transmits measurements to a Location Management Function (LMF) of the NW, including latitude, longitude, altitude, Physical Cell Identity (PCI), Global Cell Identity (GCI), Absolute Radio Frequency Channel Number (ARFCN), PRS resource identifiers, and Downlink-PRS-RS Received Power (DL-PRS-RSRP). The UE transmission includes timestamps, DL-PRS receive beam index, first path DL-PRS-RSRP results, and line-of-sight/non-line-of-sight (LoS/NLoS) information. However, sensing and tracking of targets are insufficient.

### SUMMARY

In certain representative embodiments, a method performed by a wireless transmit/receive unit (WTRU) is provided for a sensing task. For example, the method includes receiving a configuration from a network for sensing. Also, for example, the configuration comprises a configured measurement of a target object. Further, for example, the method comprises receiving a reference signal. In addition, for example, the method comprises determining an observed measurement of the reference signal. Moreover, for example, the method comprises comparing the configured measurement of the target object and the observed measurement of the reference signal. Furthermore, for example, the method comprises determining a mismatch detection event based on the comparing. Additionally, for example, the method comprises controlling bandwidth aggregation for sensing based on the determined mismatch detection event. Still further, for example, the method comprises transmitting a report to the network. Even further, for example, the report comprises an indicator of the determined mismatch detection event.

For example, the configuration comprises a bandwidth aggregation configuration comprising one or more triggers for at least one of activating, deactivating, increasing, or decreasing the bandwidth aggregation. Also, for example, the controlling the bandwidth aggregation for sensing comprises the at least one of the activating, the deactivating, the increasing, or the decreasing the bandwidth aggregation. Further, for example, the controlling the bandwidth aggregation for sensing is further based on the one or more triggers. In addition, for example, the one or more triggers (for the bandwidth aggregation) comprises at least one of an event-based trigger, a time-based trigger, a location-based trigger, a mobility-based trigger, or a quality of service-based trigger. Moreover, for example, the report comprises information of a recommended reference signal bandwidth aggregation.

For example, the configuration comprises a measurement search window configuration specifying a measurement search window comprising one or more triggers for at least one of activating, deactivating, length increasing, or length decreasing the measurement search window. Also, for example, the comparing the configured measurement of the target object and the observed measurement of the reference signal comprises measuring the reference signal within the measurement search window specified in the measurement search window configuration. Further, for example, the method comprises utilizing the bandwidth aggregation within the measurement search window based on the determined mismatch detection event. In addition, for example, the one or more triggers (for the measurement search window) comprises at least one of an event-based trigger, a time-based trigger, a location-based trigger, a mobility-based trigger, or a quality of service-based trigger. Moreover, for example, the report comprises information of a recommended length of the measurement search window.

For example, the comparing the configured measurement of the target object and the observed measurement of the reference signal comprises determining a difference between the configured measurement of the target object and the observed measurement of the reference signal at a configured target time of arrival or a configured target angle of arrival. Also, for example, the comparing the configured measurement of the target object and the observed measurement of the reference signal comprises comparing the difference to a preconfigured threshold. Further, for example, each of the configured measurement of the target object and the observed measurement of the reference signal is at least one of a reference signal received power per path, a reference signal carrier phase, a signal to interference noise ratio, a carrier to interference ratio, or a reference signal profile.

For example, the method comprises receiving a subsequent reference signal. Also, for example, the method comprises determining a subsequent observed measurement of the subsequent reference signal. Further, for example, the method comprises comparing the configured measurement of the target object and the subsequent observed measurement of the subsequent reference signal. In addition, for example, the method comprises determining a true match detection event based on the comparing. Moreover, for example, the method comprises deactivating bandwidth aggregation for sensing based on the determined true match detection event. Furthermore, for example, the method comprises transmitting a subsequent report to the network. Additionally, for example, the subsequent report comprises an indicator of the determined true match detection event.

In certain representative embodiments, a wireless transmit/receive unit (WTRU) for a sensing task is provided. For example, the WTRU comprises a processor. Also, for example, the WTRU comprises a transceiver coupled to the processor. Further, for example, the WTRU is to receive a configuration from a network for sensing. In addition, for example, the configuration comprises a configured measurement of a target object. Moreover, for example, the WTRU is to receive a reference signal. Furthermore, for example, the WTRU is to determine an observed measurement of the reference signal. Additionally, for example, the WTRU is to compare the configured measurement of the target object and the observed measurement of the reference signal. Still further, for example, the WTRU is to determine a mismatch detection event based on the comparing. Even further, for example, the WTRU is to control bandwidth aggregation for sensing based on the determined mismatch detection event. Yet further, for example, the WTRU is to transmit a report to the network. Further still, for example, the report comprises an indicator of the determined mismatch detection event.

For example, the configuration comprises a bandwidth aggregation configuration comprising one or more triggers for at least one of activating, deactivating, increasing, or decreasing the bandwidth aggregation. Also, for example, the controlling the bandwidth aggregation for sensing comprises the at least one of the activating, the deactivating, the increasing, or the decreasing the bandwidth aggregation. Further, for example, the controlling the bandwidth aggregation for sensing is further based on the one or more triggers. In addition, for example, the one or more triggers (for the bandwidth aggregation) comprises at least one of an event-based trigger, a time-based trigger, a location-based trigger, a mobility-based trigger, or a quality of service-based trigger. Moreover, for example, the report comprises information of a recommended reference signal bandwidth aggregation.

For example, the configuration comprises a measurement search window configuration specifying a measurement search window comprising one or more triggers for at least one of activating, deactivating, length increasing, or length decreasing the measurement search window. Also, for example, the WTRU to compare the configured measurement of the target object and the observed measurement of the reference signal is to measure the reference signal within the measurement search window specified in the measurement search window configuration. Further, for example, the WTRU is to utilize the bandwidth aggregation within the measurement search window based on the determined mismatch detection event. In addition, for example, the one or more triggers (for the measurement search window) comprises at least one of an event-based trigger, a time-based trigger, a location-based trigger, a mobility-based trigger, or a quality of service-based trigger. Moreover, for example, the configuration comprises information of a recommended length of the measurement search window.

For example, the WTRU to compare the configured measurement of the target object and the observed measurement of the reference signal is to determine a difference between the configured measurement of the target object and the observed measurement of the reference signal at a configured target time of arrival or a configured target angle of arrival. Also, for example, the WTRU to compare the configured measurement of the target object and the observed measurement of the reference signal is to compare the difference to a preconfigured threshold. Further, for example, each of the configured measurement of the target object and the observed measurement of the reference signal is at least one of a reference signal received power per path, a reference signal carrier phase, a signal to interference noise ratio, a carrier to interference ratio, or a reference signal profile.

For example, the WTRU is to receive a subsequent reference signal. Also, for example, the WTRU is to determine a subsequent observed measurement of the subsequent reference signal. Further, for example, the WTRU is to compare the configured measurement of the target object and the subsequent observed measurement of the subsequent reference signal. In addition, for example, the WTRU is to determine a true match detection event based on the comparing. Moreover, for example, the WTRU is to deactivate bandwidth aggregation for sensing based on the determined true match detection event. Furthermore, for example, the WTRU is to transmit a subsequent report to the network, the subsequent report comprising an indicator of the determined true match detection event.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram, according to one or more embodiments;

FIG. 3 is a chart of normalized reception power over time, according to one or more embodiments;

FIG. 4 is a flow chart illustrating a method, according to one or more embodiments; and

FIG. 5 is a flow chart illustrating another method, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

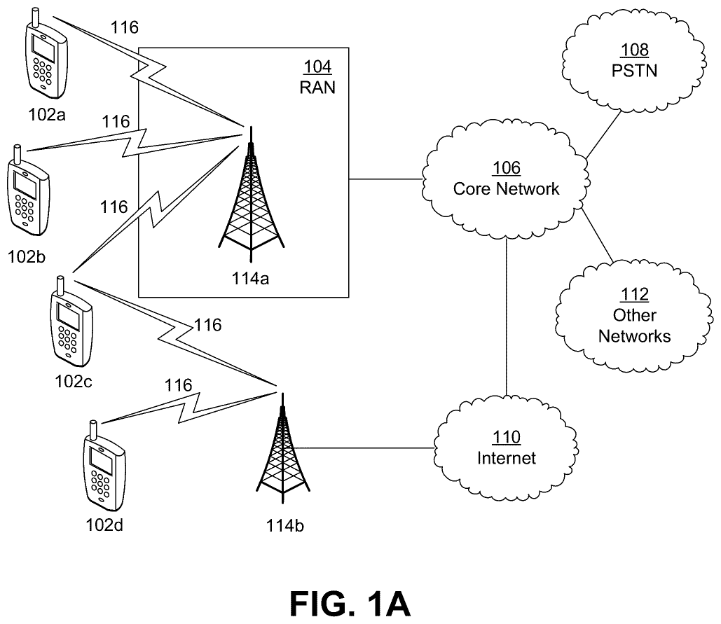

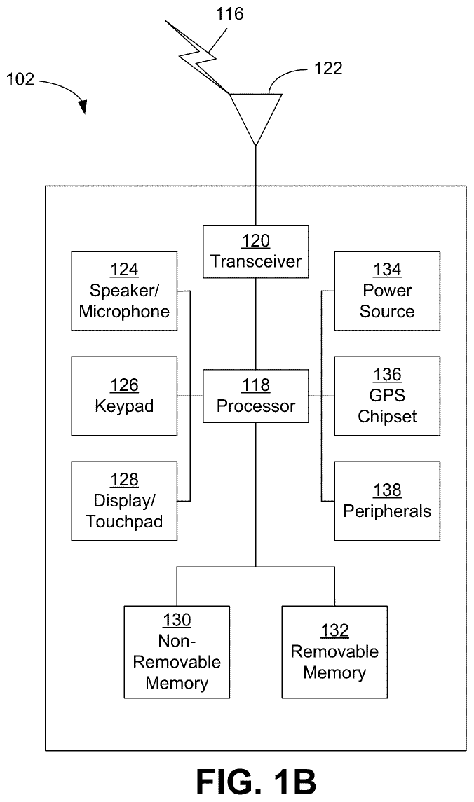

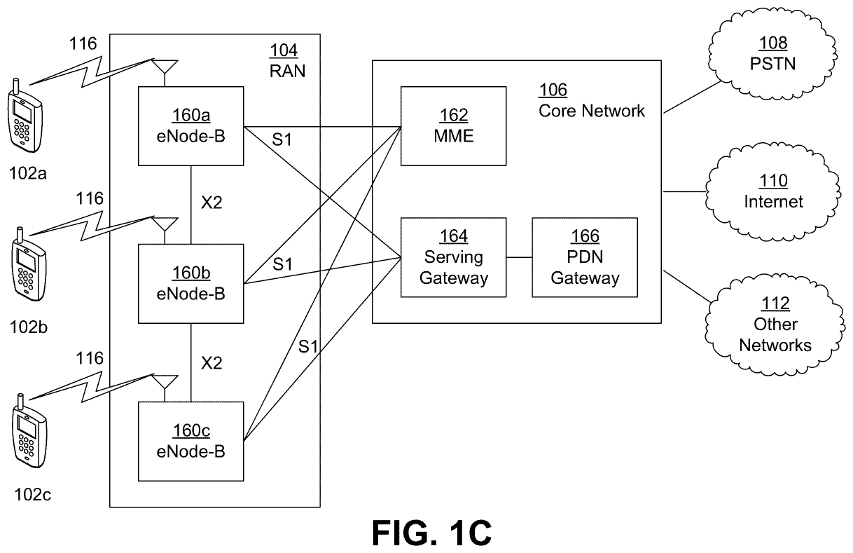

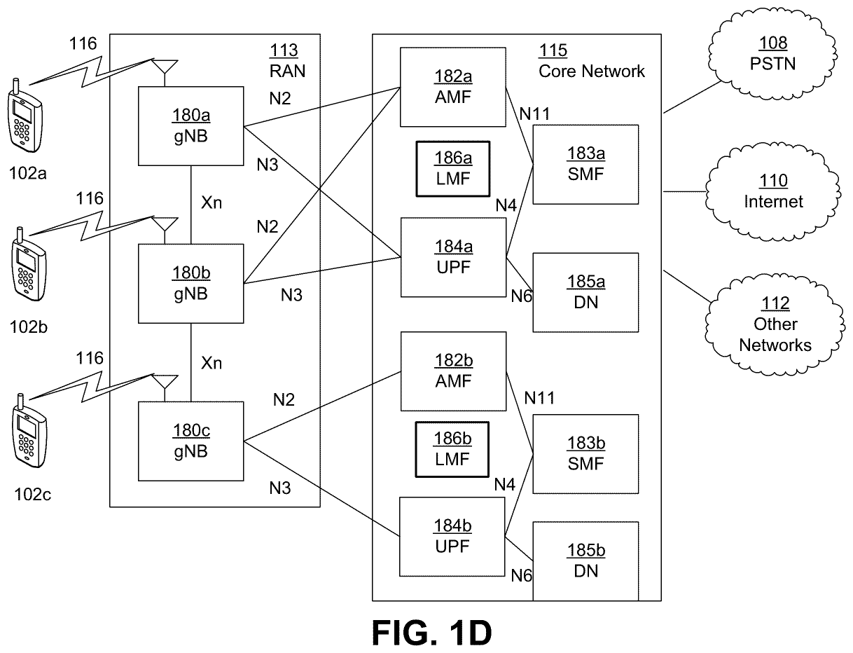

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, routing of location information towards location management functions (LMFs) 186a, 186b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

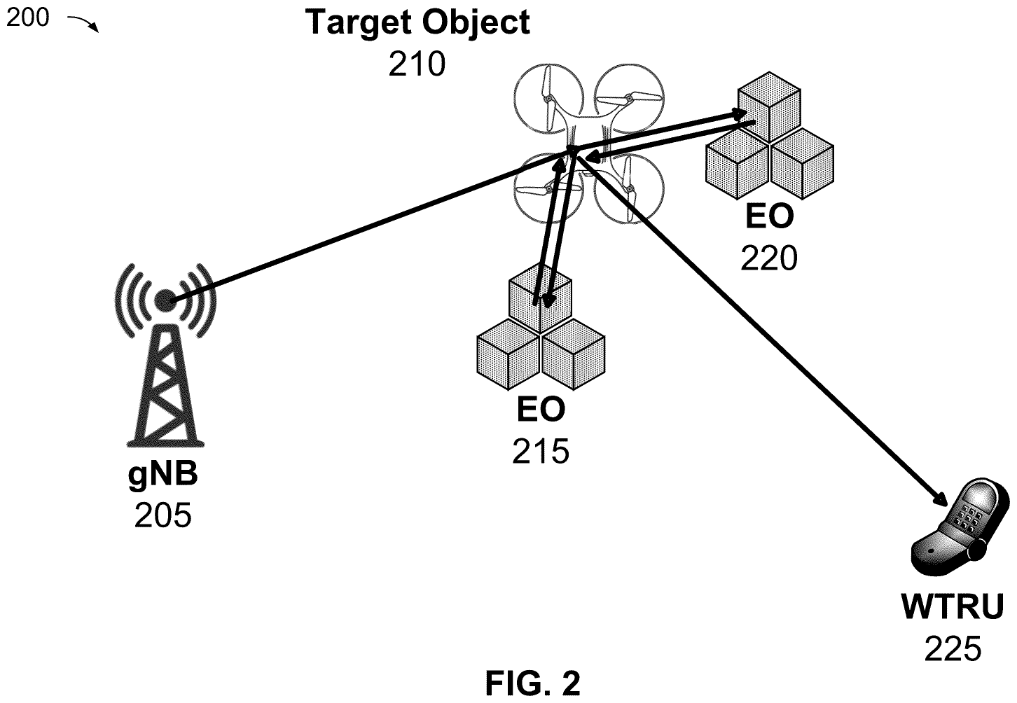

Improvements in sensing (e.g., Integrated Sensing and Communication (ISAC)) are provided. For example, improvements in sensing include at least one of target true match and/or mismatch detection, RS bandwidth aggregation (e.g., within a measurement search window), or resolvable and/or unresolvable target and/or environmental (EO) detection. In certain representative embodiments, a WTRU (e.g., 102 in FIG. 1B, or 225 in FIG. 2) determines a target mismatch detection event based on and/or utilizing at least one of an initial configuration of the WTRU 102/225 (e.g., including a configured target profile), reception of RS, performing one or more configured measurements, determination of a target mismatch detection event (e.g., by comparing one or more RS measurements and a configured sensing target profile), activation of RS bandwidth aggregation (e.g., within a measurement search window), or reporting to a network (NW). The reporting to the NW includes, e.g., a configured time granularity, a detected RS metric profile, an indicator of target true match and/or mismatch detection, or detection of a resolvable target and/or an unresolvable target and/or an EO (e.g., within the measurement search window).

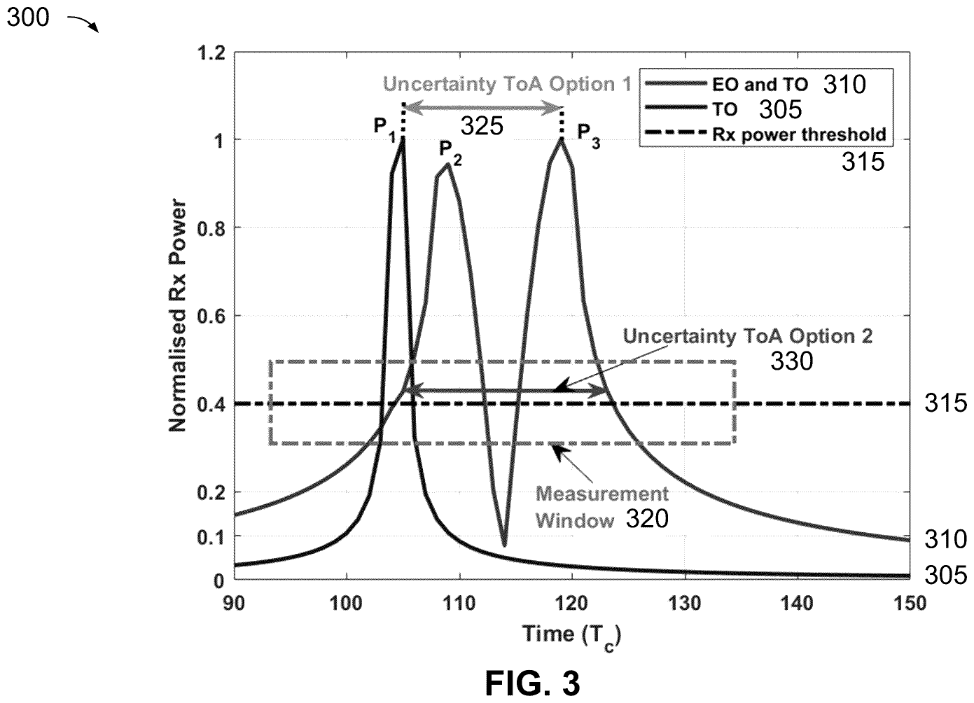

A sensing target may be in proximity of one or more environmental objects (EOs). The presence of EOs creates difficulties for sensing the target, e.g., in the absence of any prior knowledge (i.e., information) of the EOs, e.g., radar cross section (RCS), location, or the like. The measured metrics from the reflected reference signal (RS) may be shaped by the combined RCS from the sensing target and EOs. See, for example, interference with the sensing of a target object caused by EOs as shown in FIG. 3, described in greater detail below. Also, the measured metrics of reflected RS from the sensing target may carry the micro-doppler (MD) signature of both the target and the EOs based on the micro-motion (e.g., rotation, vibration, or the like) of the target or the EOs. However, compared to an RCS profile, an MD profile of the target is more robust against multiple reflections from EOs, e.g., EOs that have similar sizes like the target (e.g., birds, animals, or the like). In this case, a power-delay profile or a channel impulse response may carry one or more types of information regarding a target background environment. The WTRU 102/225 may assist the NW to achieve improved target sensing, e.g., in the presence of one or more relatively close EOs, e.g., through conducting and reporting on specific configured measurements.

In certain representative embodiments, a configuration for Downlink (DL)-RS is provided. In one example, a DL-RS configuration may contain at least one of the following parameters: a number of symbols, transmission power, a number of DL-RS resources included in a DL-RS resource set, a muting pattern for the DL-RS (e.g., the muting pattern may be expressed via a bitmap), a periodicity, a type of the DL-RS (e.g., periodic, semi-persistent, or aperiodic), a slot offset for periodic transmission for the DL-RS, a vertical shift of a DL-RS pattern in a frequency domain, a time gap during repetition, a repetition factor, a Resource Element (RE) offset, a comb pattern, a comb size, a spatial relation (e.g., with respect to other DL-RSs or Uplink (UL) RS such as a Sounding Reference Signal (SRS) for a positioning purpose), Quasi Co-Location (QCL) information (e.g., QCL target, QCL source) for the DL-RS, a number of transmission reception points (TRPs), an Absolute Radio Frequency Channel Number (ARFCN), subcarrier spacing, an expected Reference Signal Time Difference (RSTD), an uncertainty in an expected RSTD, a start Physical Resource Block (PRB), a bandwidth, a bandwidth part (BWP) ID, a number of frequency layers, a start time and/or an end time for a DL-RS transmission, an on and/or off indicator (e.g., for DL-RS, TRP ID, DL-RS ID, cell ID, global cell ID, or the like), an applicable time window, combinations of the same, or the like. The WTRU 102/225 may apply a DL-RS configuration under a condition that the current time is within the applicable time window. “ID” may be used interchangeably with “index”. Examples of DL-RS include a CSI-RS, a Phase Tracking Reference Signal (PTRS), a Positioning Reference Signal (PRS), a TRS, and a Synchronization Signal Block (SSB).

A configuration for UL-RS is provided. In one example, a UL-RS or SRS configuration may include at least one of: a resource 1D; comb offset values and/or cyclic shift values; a start position in the frequency domain; a number of UL-RS symbols; a shift in the frequency domain for UL-RS; a frequency hopping pattern; a type of UL-RS (e.g., aperiodic, semi-persistent or periodic); a sequence ID used to generate UL-RS, or other IDs used to generate a UL-RS sequence; spatial relation information, indicating which reference signal (e.g., DL-RS, UL-RS, CSI-RS, SRS, or DM-RS) or SSB (e.g., SSB ID, or cell ID of the SSB) the UL-RS is related to spatially, e.g., where the UL-RS and DL-RS may be aligned spatially; QCL information (e.g., a QCL relationship between UL-RS and other reference signals or SSB); a QCL type (e.g., QCL type A, QCL type B, QCL type C, or QCL type D); a resource set ID; a list of UL-RS resources in the resource set; transmission power related information; pathloss reference information, which may contain an index for SSB, CSI-RS, or DL-RS; a periodicity of UL-RS transmission; and/or spatial information, such as spatial direction information of UL-RS transmission (e.g., beam information, or angles of transmission), and/or spatial direction information of DL-RS reception (e.g., beam ID used to receive DL-RS, or angle of arrival). “ID” may be used interchangeably with “index”.

### Terminology

In this disclosure, “Network” may include AMF (e.g., 182a, 182b), LMF (e.g., 186a, 186b), gNB (e.g., 180a, 180b, 180c), RAN (e.g., RAN 104), next generation RAN (NG-RAN), or the like. “Pre-configuration” and “configuration” may be used interchangeably in this disclosure. “Non-serving gNB” and “neighboring gNB” may be used interchangeably in this disclosure. The terms “gNB” and “TRP” may be used interchangeably in this disclosure. “DL-RS” or “DL-RS resource” may be used interchangeably in this disclosure. “DL-RS(s)” or “DL-RS resource(s)” may be used interchangeably in this disclosure. The aforementioned “DL-RS(s)” or “DL-RS resource(s)” may belong to different DL-RS resource sets. “Measurement gap” or “measurement gap pattern” may be used interchangeably in this disclosure. “Measurement gap pattern” may include parameters such as measurement gap duration or measurement gap repetition period or measurement gap periodicity.

An LMF (e.g., 186a, 186b) is a non-limiting example of a node or entity (e.g., network node or entity) that may be used for or to support positioning and/or sensing. Any other node or entity may be substituted for the LMF and still be consistent with this disclosure.

The WTRU 102/225 may receive a preconfigured threshold(s) from the network (e.g., LMF, gNB). The line-of-sight (LoS) indicator may be a hard (e.g., 1 or 0) or soft indicator (e.g., 0, 0.1, 0.2 . . . , 1). The LoS indicator indicates likelihood of the presence of an LoS path between TRP and WTRU 102/225 or along DL-RS. The LoS indicator can be associated with a TRP or PRS resource ID (e.g., index). The WTRU 102/225 may receive the LoS indicator from the network per TRP or resource ID. Alternatively, the WTRU 102/225 may determine the LoS indicator per TRP, or resource ID based on measurements.

In the examples described herein, “ID” and “index” may be used interchangeably.

A WTRU 102/225 location may be expressed in terms of an altitude, a latitude, a geographic coordinate, or a local coordinate, for example.

In the examples described herein, a timestamp may be indicated by absolute time, relative time (e.g., in seconds) compared to a reference time, a System Frame Number (SFN), a slot index, a frame index, a subframe index, and/or a symbol index. Examples of “absolute time” may be Coordinated Universal Time (UTC) time, Global Navigation Satellite System (GNSS) time, or locally defined absolute time (e.g., Long-Term Evolution (LTE) or New Radio (NR) Time).

In certain representative embodiments, a sensing scenario is provided. For example, a sensing target is in a vicinity of one or more EOs. Also, for example, a NW has prior knowledge (i.e., information) of a location of the sensing target and one or more types of sensing target type information (e.g., human, drone, vehicle, or the like). Further, for example, a reflected RS from the location of the target object towards the WTRU 102/225 carries further unidentified reflections from one or more EOs, which induces interference to sensing information that is extracted from the reflected RS (e.g., RCS).

FIG. 2 illustrates an example of a system 200 in an ISAC environment. For example, the system 200 includes at least one of a gNB 205, a target object 210, a first EO 215, a second EO 220, a WTRU 225, combinations of the same, or the like. Also, for example, the gNB 205 is a 5G base station for controlling communication and sensing tasks. Further, for example, the target object 210 (e.g., a drone as shown in FIG. 2) is an object being tracked and/or communicated with. In addition, for example, the first EO 215 and the second EO 220 are objects (e.g., birds, animals, or the like). Moreover, for example, the first EO 215 and the second EO 220 interact with one or more signals transmitted and/or received and/or reflected to and/or from any of the gNB 205, the target object 210, or the WTRU 225.

For example, the gNB 205 generates orthogonal frequency-division multiplexing (OFDM) signals, which are used for both communication and sensing purposes. Also, for example, the OFDM signals are transmitted to the WTRU 225 for communication and to the target object 210 for sensing. Further, for example, the gNB 205 utilizes the transmitted OFDM signals to detect the presence and/or location of the target object 210. In addition, for example, detecting the presence and/or location of the target object 210 involves measuring the time delay and Doppler shift of the reflected signals. Moreover, for example, the WTRU 225 receives the communication signals and processes them for data transmission.

For example, as noted in detail above, when the target object 210 is relatively near the first EO 215 and the second EO 220, the first EO 215 and the second EO 220 complicate sensing due to unknown factors like RCS and location. Also, for example, the reflected RS metrics are influenced by both the target object 210, the first EO 215, and the second EO 220. Further, for example, an MD signature (e.g., reflecting micro-motions) is more reliable than RCS against multiple reflections from similarly sized EOs. In addition, for example, metrics (e.g., a power-delay profile or a channel impulse response) provide information about an environment of the target object 210. Moreover, for example, the WTRU 225 improves sensing by conducting and reporting specific measurements in the presence of the first EO 215 and the second EO 220. Furthermore, for example, the gNB 205 processes the received signals to extract information (e.g., position, speed, and trajectory) about the target object 210. Additionally, the processed data is used to adjust transmission parameters and improve an accuracy of both communication and sensing tasks. Still further, for example, the system 200 operates in a cooperative framework where the gNB 205, first and second EOs 215 and 220, and WTRU 225 share information for one or more sensing tasks.

The exchange of PRS LOS and/or NLOS indication information between the WTRU 102/225 and the LMF is provided. This indication can be either hard (e.g., LoS or NLoS) or soft (e.g., an integer value that provides the likelihood of the LoS propagation). In addition to the LoS and/or NLOS indication information to detect the sensing target in the NLOS case, an association between the RS measurements and a sensing target is provided. The association between the RS measurements and the sensing target based on a target profile supports sensing use cases such as detection and tracking.

In certain representative embodiments, a WTRU 102/225 indicates and reports to a NW a mismatch detection event. For example, the mismatch detection event is associated with a reflected RS from a target, e.g., in the presence of one or more EOs, e.g., using one or more measured RS metrics (e.g., RS received power per path (RSRPP), RS carrier phase (RSCP), signal to interference noise ratio (SINR), or the like) and a configured target profile.

In certain representative embodiments, the WTRU 102/225 receives a configuration from a NW for performing sensing measurements including one or more thresholds to detect when a sensing target is unresolvable. For example, as part of the configuration, the WTRU 102/225 receives from the NW sensing target assistance information. Also, for example, the WTRU 102/225 receives an RS reflected from a target location and performs sensing measurements based on the received RS. Further, for example, the WTRU 102/225 determines a “target mismatch detection” event based on comparison between an RS measurement and a configured target profile at a configured angle-of-arrival (AoA) and/or time-of-arrival (ToA). In addition, for example, the WTRU 102/225 activates bandwidth aggregation within a measurement search window (e.g., where a length of the measurement search window is preconfigured by the NW). Moreover, for example, the WTRU 102/225 sends a report to the NW. Furthermore, for example, the report contains one or more details associated with at least one of a triggered event, a detected resolvable and/or unresolvable target, and/or EO within the measurement search window.

Exemplary definitions for a mismatch detection event, an unresolvable target and/or EO event, uncertainty in AoA and/or ToA, and aggregated RS resources as used herein are provided as follows.

For example, a mismatch detection event is an event in which a measured metric of a received RS (e.g., RSRPP, RSCP, or the like) from a location of a configured target (e.g., AoA and/or ToA) does not match, e.g., one or more expected metrics, e.g., based on a profile of the configured target.

For example, an unresolvable target and/or EO event is an event in which a measured metric of a received RS (e.g., RSRPP, RSCP, or the like) from a location of a configured target (e.g., AoA and/or ToA) within a measurement search window indicates a presence of an unresolvable target and/or EO. Also, for example, the unresolvable target and/or EO event refers to a detection of a number of RS metric peaks within a measurement search window that exceeds a configured threshold. Further, for example, the unresolvable target and/or EO event refer to a scenario where a measured uncertainty, e.g., in a ToA and/or an AoA for a peak of the RS metric, e.g., within a measurement search window, is above a configured threshold.

For example, an uncertainty range in AoA and/or ToA corresponds with a range of a measured ToA and/or AoA that is associated with a measured RS metric peak within a measurement search window. Also, for example, the uncertainty in the ToA and/or AoA for an RS metric peak is measured, such as a range of ToA and/or AoA where the RS metric peak value decreases below a preconfigured threshold. Further, for example, the uncertainty in the ToA and/or AoA for the RS metric peak is measured, such as a range of the ToA and/or AoA between a configured target ToA and/or AoA and a measured RS metric peak AoA and/or ToA.

For example, aggregated RS resources refers to a scenario in which a WTRU 102/225 is expected (i.e., is programmed and/or configured) to perform aggregated measurements for bandwidth aggregation across DL-RS frequency layers. Also, for example, the WTRU 102/225 expects to be configured with linkage information, via a higher layer parameter between DL-RS resource sets across DL-RS frequency layers. Further, for example, for linked DL-RS resource sets, the WTRU 102/225 is expected to be configured with the same values (e.g., periodicity, QCL, repetition factor, subcarrier spacing, comb size, or the like), and the WTRU 102/225 is expected to be configured with DL-RS resources that maintain a uniformly spaced DL-RS RE pattern within a symbol across aggregated DL-RS frequency layers. In addition, for example, the WTRU 102/225 assumes (i.e., is programmed and/or configured) that DL-RS resources across the linked DL-RS resource sets that satisfy one or more of the above conditions are linked for bandwidth aggregation. Moreover, for example, the WTRU 102/225 assumes phase continuity on the DL-RS resources on one or more same symbols; otherwise, the WTRU 102/225 does not assume that RS resources from the linked DL-RS resource sets are linked for bandwidth aggregation.

In certain representative embodiments, a WTRU 102/225 is configured to perform one or more actions and/or steps detailed herein. For example, the WTRU 102/225 is configured to perform at least one of receiving a configuration, receiving a sensing RS, aggregating RS bandwidth, reporting one or more measurements, decoding a report from the reporting, combinations of the same, or the like.

In certain representative embodiments, a WTRU 102/225 is configured to receive a configuration. For example, a WTRU 102/225 (e.g., the WTRU 102/225 configured to report measurements requested by a network) receives a configuration from a network (e.g., via radio resource control (RRC) signaling, Medium Access Control (MAC) control element (MAC-CE), or downlink control information (DCI)). Also, for example, receiving the configuration from the network is associated with a sensing task related to a sensing target. Further, for example, the configuration includes at least one of a sensing RS configuration (e.g., positioning RS (PRS) or equivalent), sensing RS measurement and reporting configurations, sensing assistance information for a sensing target, combinations of the same, or the like.

For example, sensing RS measurement and reporting configurations include at least one of: one or more metrics to be measured, one or more target profile types, one or more thresholds for detection, one or more thresholds for reporting, one or more bandwidth aggregation configurations, one or more RS path delay and/or ToA measurement configurations, one or more measurement search window configurations, one or more reporting configurations, one or more RS metric peak detection configurations, combinations of the same, or the like. Also, for example, metrics to be measured include at least one of RS received power (RSRP), RSRPP, RSCP, AoA, combinations of the same, or the like. Further, for example, a target profile type includes at least one of frequency, time, angle, combinations of the same, or the like. In addition, for example, one or more thresholds for detection include one or more thresholds for a mismatch detection event. Moreover, for example, one or more thresholds for reporting include one or more thresholds for updating a report, or the like. Furthermore, for example, a bandwidth aggregation configuration includes one or more triggering events for bandwidth aggregation. Additionally, for example, a measurement search window configuration includes one or more triggering events. Still further, for example, a reporting configuration includes one or more reporting resources for one or more types of triggered events and/or time granularity for a reported measurement, periodicity information, and decoding information for each report type. Even further, for example, a RS metric peak detection configuration includes a peak measurement determined based on a minimum threshold difference between a point and one or more neighbor points, a peak measurement determined based on a gradient method, or the like. Yet further, for example, sensing assistance information for sensing a target includes at least one of a sensing target identifier, sensing target profile information, sensing target positioning information, combinations of the same, or the like.

In certain representative embodiments, a WTRU 102/225 is configured to receive a sensing RS. For example, the sensing RS is reflected from a sensing target location. Also, for example, the WTRU 102/225 determines a mismatch detection event based on one or more configured conditions. Further, for example, the WTRU 102/225 determines a true match detection event based on one or more configured conditions. In addition, for example, the WTRU 102/225 determines a mismatch or true match detection event based on a difference between a measured and configured target RS-metric (e.g., RSRPP, RSCP, SINR, CIR, or the like) at a configured target ToA and/or AoA. Moreover, for example, the WTRU 102/225 determines a mismatch or true match detection event based on the difference being above (or below) a preconfigured threshold. Furthermore, for example, the WTRU 102/225 determines a mismatch or true match detection event based on a difference between a measured and configured target RS-metric profile at a configured target ToA and/or AoA. Additionally, for example, the WTRU 102/225 determines a mismatch or true match detection event based on the difference being above (or below) a preconfigured threshold.

In certain representative embodiments, a WTRU 102/225 is configured to be triggered to aggregate RS bandwidth to measure a reflected RS from a target location within a measurement search window. For example, the WTRU 102/225 determines the measurement search window based on preconfigured criteria.

In certain representative embodiments, a WTRU 102/225 is configured to send to a NW a measurement sensing report of a target with time granularity based on one or more determined triggered events.

In certain representative embodiments, a WTRU 102/225 is configured to cause a NW to receive a measurement sensing report from the WTRU 102/225. For example, the WTRU 102/225 is configured to cause the NW to decode the report based on reported WTRU 102/225 decoding information and/or blind decoding criteria.

As provided in detail herein, methods, WTRUs, and networks provide one or more benefits. For example, a WTRU 102/225 is configured to detect a mismatch detection event (e.g., due to a presence of an EO). Also, for example, the WTRU 102/225 configured to detect the mismatch detection event triggers one or more sensing measurements having a higher granularity. Further, for example, the WTRU 102/225 configured to detect the mismatch detection event that triggers the one or more sensing measurements having the higher granularity improves a probability of accurately detecting a target through one or more sensing tasks.

In certain representative embodiments, methods are provided for sensing in the presence of one or more EOs. For example, the methods provided for sensing in the presence of one or more EOs include at least one of providing one or more configurations, providing sensing assistance information, performing one or more sensing measurement events, providing one or more triggers for one or more sensing measurement events, methods of controlling WTRU behavior, methods for WTRU reporting, methods for updating WTRU reporting, methods of terminating WTRU reporting, combinations of the same, or the like.

In certain representative embodiments, one or more configurations are provided. For example, the WTRU 102/225 receives a network request to provide capability information, detailing sensing capabilities such as, e.g., processing capabilities, frequency ranges, bandwidth, modes, and spatial and time resolution. Also, for example, after sending the information back to the network, the WTRU 102/225 is configured to start a sensing task related to a specific target. Further, for example, the network provides details on the sensing measurement event and sets triggers for initiating or terminating the task based on time, events, location, mobility, or QoS parameters.

For example, the WTRU 102/225 receives and decodes a first network request, e.g., received through RRC signaling, to provide capability information. Also, for example, the WTRU 102/225 may receive and decode this first network request following the random-access procedure. Further, for example, the WTRU 102/225 prepares a capability information message including information related to sensing capabilities such as scatterers and clutter identification.

For example, the information contained in the WTRU capabilities message may include at least one of the following: sensing processing capabilities, e.g., inverse frequency transform capabilities, maximum number of samples, or the like; sensing frequency ranges; sensing bandwidth; sensing modes, e.g., monostatic, bistatic, or the like; sensing priorities; sensing spatial resolution; sensing time resolution; support of AoA determination and related angular resolution; sensing doppler resolution; reflectivity sensitivity, e.g., the minimum power, SNR, absolute amplitude, or the like, for the reflections to be detectable by the WTRU 102/225; support of carrier phase measurements and related phase resolution; support of half-duplex or full-duplex for monostatic sensing, and related parameters (e.g., frequency range, maximum allowed transmit power for sensing, or the like); combinations of the same; or the like.

For example, the WTRU 102/225 sends the WTRU capability information message through RRC signaling, e.g., over the Physical Uplink Shared Channel (PUSCH). Also, for example, the WTRU 102/225 receives a configuration from the network that may include an indication from the network to start a sensing task that is related to a sensing target (e.g., target localization, tracking, or the like). Further, for example, the WTRU 102/225 receives the configuration via RRC signaling, MAC-CE, or DCI. In addition, for example, the configuration includes a sensing measurement event (e.g., target true match and/or mismatch detection, resolvable and/or unresolvable target detection, or the like) and corresponding triggers that may include one or more parameters.

For example, the one or more parameters include at least one of a target sensing task configuration, a sensing measurement event ID, reference signal information and/or a DL reference signal configuration, one or more metrics to be used for the target sensing task measurement, one or more types of RS metric profiles to be measured for the target sensing task measurement, one or more thresholds for sensing measurement event detection, a bandwidth aggregation configuration, a measurement search window configuration, a reporting configuration, an RS path delay and/or a ToA measurement configuration, an RS metric peak detection configuration, combinations of the same, or the like.

For example, a target sensing task configuration may include at least one of the following: one or more indications (e.g., such as a flag) to activate the target sensing measurements, one or more triggers for initiating or terminating the target sensing measurement procedure, target sensing task measurement reporting information, combinations of the same, or the like.

For example, the time window for the target sensing task measurement procedure includes at least one of a start time, a minimum and/or maximum duration, a number of measurement occasions for update and termination, combinations of the same, or the like.

For example, the one or more triggers for initiating or terminating the target sensing task measurement procedure includes at least one of: time-based triggers, e.g., the WTRU 102/225 initiating or terminating and target sensing task measurements at predefined intervals for periodic monitoring; event-based triggers, e.g., WTRU 102/225 initiating or terminating target sensing task measurements when certain signal parameters such as SINR fall below configured thresholds; location-based triggers, e.g., when WTRU 102/225 enters and/or leaves certain geographical area, or when it detects proximity to a particular target or location; mobility-based triggers, e.g., accounting for WTRU 102/225 being stationary or mobile, QoS-based triggers, e.g., based on sensing accuracy or resolution, positioning-based QoS (e.g., positioning resolution in meters) and reliability-based QoS (e.g., missed detection and false alarm percentages); combinations of the same; or the like.

In one example, the WTRU 102/225 may be triggered to initiate or terminate target sensing task if the measured WTRU location (e.g., using radio access technology (RAT)-dependent and/or independent methods) and the configured target location is below a certain threshold.

In one example, the WTRU 102/225 may be triggered to activate or deactivate target sensing task if the measured WTRU velocity is above a threshold value and/or within a range of threshold values. In another example, the WTRU 102/225 may be triggered to activate or deactivate target sensing task if the difference between the measured WTRU velocity and the configured target velocity is below a threshold value.

For example, the target sensing task measurement reporting information includes at least one of: a reporting type, e.g., periodic, semi-periodic, aperiodic; reporting thresholds, e.g., conditions for WTRU 102/225 to report target sensing task measurement information based on changes in the target sensing task or other predefined criteria; reporting content and format, e.g., raw versus processed data, statistical or instantaneous data, or the like; timing reporting granularity factor; reporting resources, e.g., uplink resources such as transmission power, resource blocks, and scheduling information; error handling and re-sensing strategies; combinations of the same; or the like.

In one example, the report content may be based on the detected sensing measurement event, e.g., target only report or target and environmental object report, target true match and/or mismatch detection report, resolved and/or unresolved target report, or the like.

In one example, the timing reporting granularity factor may be configured based on the sensing measurement event detected. For example, target true match detection corresponds to timing reporting granularity factor x, and target mismatch detection corresponds to timing reporting granularity y. In another example, the timing reporting granularity may be configured based on measured RS metrics such as: RSRP, RSRPP, CIR, SINR, RSRQ, or the like.

For example, the sensing measurement event ID may include at least one of the following: sensing measurement event instance ID (e.g., ID target true match detection, ID for target mismatch detection, ID resolvable target detection, ID unresolvable target detection, or the like); RS ID (e.g., PRS beam ID(s)); target ID(s); combinations of the same; or the like.

For example, the reference signal information and/or DL reference signal configuration includes at least one of: reference signal types, for example PRS; resource sets; time and/or frequency characteristics such as pattern and density; cover codes; periodicity, time gap, and comb size; power settings; beamforming and/or precoding related information (e.g., beam IDs, transmission configuration indicator (TCI) settings, QCL info, or the like); combinations of the same; or the like.

For example, the metrics to be used for the target sensing task measurement, e.g., in relation to reference signals, includes at least one of the following: RSRP; RSRPP; reference signal received quality (RSRQ); SINR; channel quality indicator (CQI); rank indicator (RI); precoding matrix indicator (PMI); timing advance (TA); combinations of the same; or the like.

For example, the types of RS metric profiles to be measured for the target sensing task measurement includes at least one of: RS metric-frequency profile information (e.g., relative received amplitude and optionally phase at one or more frequencies and/or physical resource block (PRB)); RS metric-angular profile (e.g., relative received power at a set of relative AoA and/or angle-of-departure (AoD)); RS metric-time profile information (e.g., relative received amplitude and optionally phase at one or more time slots and/or PRB); combinations of the same; or the like.

For example, the thresholds for sensing measurement event detection, reporting, report update and termination includes at least one of: a static threshold to determine the detection of sensing measurement event (e.g., the difference between a measured and configured target profile, the difference between the measured and configured RS profile, or the like); measurement accuracy thresholds; update thresholds, termination thresholds, or the like; combinations of the same; or the like.

For example, the bandwidth aggregation configuration includes at least one of the following: set of RS resource ID(s) or resource set ID(s) that are assigned for RS bandwidth aggregation; RS resource ID(s) or resource set ID(s) configuration (e.g., periodicity, comb-size, muting pattern, subcarrier spacing, or the like); triggers for activating, deactivating, increasing and/or decreasing of the bandwidth aggregation; combinations of the same; or the like. Also, for example, the triggers include at least one of: event-based triggers; time-based triggers; location-based triggers; mobility-based triggers; QoS-based triggers; combinations of the same; or the like.

For example, the measurement search window configuration includes at least one of the following: length (absolute, relative to the target size, or the like); start time (measured in relative to first reflected path time, LoS path time, target configured ToA, or the like); triggers for activating, deactivating, length increasing and/or decreasing of the measurement search window; combinations of the same; or the like. Also, for example, the triggers include at least one of: event-based triggers; time-based triggers; location-based triggers; mobility-based triggers; QoS-based triggers; combinations of the same; or the like.

For example, the reporting configuration includes at least one of the following: allocated reporting uplink control and/or data channels; periodicity of reporting information; report content; combinations of the same; or the like. Also, for example, the allocated reporting uplink control and/or data channels includes at least one of: a number of allocated channels; a type of allocated channels; a type of allocation (e.g., uplink channel x is allocated to report y, uplink channel x is allocated to periodic reporting, uplink channel x is allocated to report on event y, or the like); combinations of the same; or the like. Further, for example, the periodicity of reporting information includes at least one of: a type (periodic, aperiodic, semipersistent, or the like); a period time between two successive reports (e.g., periodic and semipersistent); report types associated to each periodicity type (e.g., report x is periodic, while report y is semipersistent, or the like); combinations of the same; or the like. In addition, for example, the report content includes at least one of events detected; time granularity of the measurements reported; BW aggregation information; measurement search window information; combinations of the same; or the like.

For example, the RS path delay and/or ToA measurement configuration includes at least one of: reporting the timing of each RS path relative to the path timing used for determining RSTD or WTRU Rx-Tx time difference; reporting the timing of each RS path relative to the ToA and/or path delay of the RS that is reflected from a reference target (e.g., tree, building, or the like); reporting the timing of each RS path relative to the ToA and/or path delay of first path; reporting the timing of each RS path relative to the ToA and/or path delay of LoS path; combinations of the same; or the like.

For example, regarding the RS metric peak detection configuration, the WTRU 102/225 may be configured to determine the peak in the RS metric that is measured over a configured measurement window. Also, for example, the determining the peak in the RS metric that is measured over the configured measurement window includes at least one of: a maximum value, e.g., the RS metric peak is the maximum value of the measured RS values over the measurement window; a difference threshold value, e.g., the RS metric peak is the measured RS metric that is greater than the previous and following measured RS metric such that the difference between the current RS metric and the previous and/or following RS metric is greater than a difference threshold value; a gradient or slope method, e.g., the RS metric peak is determined based on the value of the RS metric gradient value over a measurement window; combinations of the same; or the like. Also, for example, if the RS peak is at the RS n measurement, then the RS metric gradient value at n is zero or below a threshold minimum value, the RS metric gradient value at n−1 is positive value, and the RS metric gradient value at n+1 is negative value.

In one example, the WTRU 102/225 may be configured to perform RS bandwidth aggregation with the active frequency resources. For example, a frequency resource is a resource element or OFDM symbol that is defined by a time duration and bandwidth. Also, for example, the active frequency resources may be the frequency and/or time resources used for communication (e.g., receiving downlink channels such as PDCCH, PDSCH, or transmitting uplink channels such as Physical Uplink Control Channel (PUCCH) or PUSCH). Further, for example, the WTRU 102/225 may be configured or receive an indication to aggregate frequency resources within the active frequency resources. In addition, for example, the WTRU 102/225 may be configured or receive an indication to aggregate frequency resources outside of the active frequency resources. Moreover, for example, if the WTRU 102/225 receives a request to aggregate frequency resources outside of the active frequency resources, the WTRU 102/225 may send a request for configuration of a time window (e.g., measurement gap) during which the WTRU 102/225 does not receive any downlink channels from the network or the WTRU 102/225 is not requested to monitor signals within the active frequency resources.

In certain representative embodiments, sensing assistance information is provided and/or configured. For example, the network provides the WTRU 102/225 with sensing assistance information to aid in performing sensing measurements. Also, for example, the sensing assistance information includes identifying the target type and location, linking target IDs with sensing event IDs, and detailing frequency, angular, and time profiles with metrics like, e.g., RSRP, SINR, and MD. Further, for example, the sensing assistance information provides absolute and relative positioning coordinates, target mobility information such as, e.g., velocity and Doppler frequency, and specifies the validity duration of the assistance information.

For example, the network can provide the WTRU 102/225 with sensing assistance information that includes parameters to aid in performing sensing measurements as part of the configuration. In one example, the WTRU 102/225 may receive the assistance information associated with the sensing target from the network. In one example, the WTRU 102/225 may receive the sensing assistance information semi-statically (e.g., via LTE positioning protocol (LPP) or RRC messages). Also, for example, the assistance information comprises at least one of the following: a sensing target identifier, an association to the sensing measurement event ID, sensing target profile information, sensing target positioning information, sensing target mobility information, validity time for sensing assistance information, combinations of the same, or the like.

For example, regarding the sensing target identifier, the identifier may be associated to the target type (e.g., human target, vehicles, rocks) and/or location. In one implementation, the IDs are selected from one or more pools. In another implementation the type is associated with the target and all targets have IDs from the same pool.

For example, regarding the association to the sensing measurement event ID, the sensing target ID may be the same or part of the sensing measurement event ID. In one example, the sensing measurement event ID may be part of the target ID. In another example, a single target ID may be associated to one or more sensing measurement event ID(s). In another example, multiple target ID(s) may be associated to one or more sensing measurement event ID(s).

For example, the sensing target profile information may include at least one of the following: RS metric-frequency profile information (e.g., relative received amplitude (e.g., RSRP, RSRPP, SINR, or the like) and optionally phase (e.g., RSCP) at one or more frequencies and/or PRB); an RS metric including an angular profile (e.g., relative received power at a set of relative AoA and/or AoD); an RS metric including time profile information (e.g., relative received amplitude and optionally phase at one or more time slots and/or PRB); RCS-frequency profile information (e.g., relative target RCS amplitude and optionally phase at one or more frequencies and/or PRB); RCS-angular profile (e.g.: relative target RCS at a set of relative AoA and/or AoD); RCS including time profile information (e.g., relative target RCS amplitude and optionally phase at one or more time slots and/or PRB); MD profile (e.g., relative target MD amplitude and optionally phase of the target configured MD frequency and/or range of frequencies (e.g., discrete, or continuous range) that corresponds to the target relative micro-motion (e.g., vibration, rotation, or the like); combinations of the same; or the like.

For example, the sensing target positioning information includes at least one of: absolute position (e.g., target coordinates (x,y,z)); relative position (e.g., with respect to the coordinates and/or the orientation of the TRP and/or the WTRU 102/225); coarse location (e.g., location is given as area defined between certain coordinates, cell ID, sector ID, or the like); combinations of the same; or the like. Also, in one example, the WTRU 102/225 may receive the TRP and/or WTRU positioning and/or orientation information to assist the WTRU 102/225 to calculate the target location in relative to the WTRU 102/225 and/or TRP locations.

For example, the sensing target mobility information includes at least one of: absolute mobility (e.g., target velocity, Doppler frequency, or the like); relative mobility (e.g., with respect to the WTRU and/or TRP velocity); an uncertainty range (e.g., velocity and/or Doppler frequency); combinations of the same; or the like.

For example, regarding the validity time for sensing assistance information, the validity time may refer to the total time duration when the sensing assistance information that is provided by the network can be associated to the target. In one example, the validity time may be configured in terms of a number of symbols, slots, frames, subframes, seconds, or the like.

In certain representative embodiments, sensing measurement events are provided and/or configured. For example, sensing measurement events include target mismatch detection, where, e.g., the measured RS metric from the target location does not match the expected profile; target true match detection, where, e.g., the measured RS metric matches the expected profile; and unresolvable target or environmental object (EO) detection, where, e.g., the RS metric profile indicates the presence of unresolvable objects. Also, for example, the events are determined based on comparisons between measured and expected metrics, with, e.g., thresholds set by the network to identify mismatches, matches, and uncertainties in the measurements.

Exemplary definitions for events are provided as follows.

For example, a target mismatch detection event is an event in which the measured RS metric of the received reference signal (e.g., RSRPP, RSCP, or the like) from the configured target location (e.g., AoA, ToA, or the like) does not match the expected RS metrics based on the configured target profile. In one example, the target mismatch detection may also indicate the mismatch between the measured and expected RS profile that is reflected from the expected target location (e.g., AoA, ToA, or the like). Also, for example, the expected RS metric or metric profile that is reflected by the target may be configured by the network. Further, for example, the target mismatch detection event may refer to the mismatch between the measured and configured target profile (e.g., RCS profile) that is measured at the WTRU 102/225 using the reflected RS from the configured target location (e.g., AoA, ToA, or the like). In one example, the WTRU 102/225 may determine match or mismatch based on the expected measurement or profile configured by the network. For example, the WTRU 102/225 may be configured, by the network, with expected AoA, ToA associated with the target, or the like. In addition, for example, if the difference between the actual measurement made by the WTRU 102/225 and expected measurement is larger than the configured threshold, the WTRU 102/225 may determine that the target mismatch detection event occurred.

For example, a target true match detection event is an event in which the measured metric and/or metric profile of the RS that is reflected from the expected target location matches the configured RS metric and/or metric profile. Also, for example, the target true match detection event may refer to the matching between the measured and configured target profile, where the target profile is measured at the WTRU 102/225 using the reflected RS from the configured target location. In one example, the WTRU 102/225 may be configured, by the network, with expected AoA, ToA associated with the target. Further, for example, if the difference between the actual measurement and configured expected measurement is less than the configured threshold, the WTRU 102/225 may determine that the target match detection event occurred.

For example, an unresolvable target and/or EO event is an event in which the measured metric spatial and/or delay profile of the received RS (e.g., RSRPP, RSCP, or the like) within a measurement search window that indicates the presence of an unresolvable EO. In one example, the unresolvable target and/or EO event may refer to the detection of number of RS metric peaks within a measurement search window that exceeds a configured threshold. In another example, the unresolvable target and/or EO event may refer to the case where the measured uncertainty in the ToA and/or the AoA for the RS metric peak within a measurement search window is above a configured threshold. Also, for example, the uncertainty in the ToA and/or AoA may be defined as the range of the measured ToA and/or AoA that is associated with the measured RS metric peak within the measurement search window. For example, the uncertainty in the ToA and/or AoA for the RS metric peak may be measured, such as the range of ToA and/or AoA where the RS metric peak value decreases below a preconfigured threshold. In another example, the uncertainty in the ToA and/or AoA for the RS metric peak may be measured, such as the range of the ToA and/or AoA between the configured target ToA and/or AoA and the measured RS metric peak AoA and/or ToA. In one example, the WTRU 102/225 may determine uncertainty based on the configured expected measurement and measurement. For example, uncertainty may be defined as the maximum absolute difference between the actual measurement and configured expected measurement. Further, for example, the uncertainty may be defined as a statistical measure such as standard deviation or variance determined based on the actual measurement and expected measurement.

For example, a resolved target and/or EO event is an event in which the measured metric spatial and/or delay profile of the received RS (e.g., RSRPP, RSCP, or the like) within a measurement search window indicates the presence of a resolvable EO. In one example, the resolved target and/or EO event may refer to the detection of number of RS metric peaks within a measurement search window that is below a configured threshold. In another example, the resolved target and/or EO event may refer to the case where the measured uncertainty in the ToA and/or the AoA for the RS metric peak within a measurement search window is below a configured threshold.

In certain representative embodiments, sensing measurement events triggers are provided and/or configured. For example, after receiving RS configurations, target sensing task time window configurations, and sensing assistance information, the WTRU 102/225 may receive RS resources and an indication from the network to start the sensing task. Also, for example, the WTRU 102/225 measures parameters like, e.g., AoA, RSRP, RSRPP, and ToA within the measurement window, profiling the metrics across different frequencies, angles, and time slots. Further, for example, the WTRU 102/225 determines target mismatch or true match events based on thresholds and reports the likelihood of the sensing measurement events as either hard (e.g., true match or mismatch) or soft (probability-based). In addition, for example, the WTRU 102/225 assesses whether a target or environmental object is resolvable based on the measured uncertainty of AoA and ToA, the number of detected RS metric peaks, and the average difference between RS metric peaks within the measurement window.

In one example, the WTRU 102/225 after receiving the RS configurations, the target sensing task time window configurations, and the sensing assistance information, may receive the RS resources. In one example, the WTRU 102/225 may receive an indication from the network to initiate the target sensing task phase.

In one example, the WTRU 102/225 measures the parameters (e.g., AoA, RSRP, RSRPP, time of arrival (ToA), or the like) and/or the parameters profile for each RS in the measurement window. In one example, the WTRU 102/225 may measure the RS-metric frequency profile through measurement of the RS metric (e.g., magnitude, power, phase) at one or more frequencies (e.g., frequency PRBs, BWPs, bands, or the like). In one example, the WTRU 102/225 may measure the RS metric angular profile through the measurement of the RS metric (e.g., magnitude, power, phase, or the like) at one or more angles that are associated with the RS resource (e.g., AoA, AoD, or the like). In one example, the WTRU 102/225 may measure the RS metric time profile, through measurement of the RS metric (e.g., magnitude, power, phase, or the like) at one or more time slots (e.g., time PRBs, symbols, frames, subframes, or the like).

In one example, the WTRU 102/225 may determine the target mismatch (or true match) event detection based on at least one of the following: the measured RS-metric (RSRPP, RSCP, SINR, CIR, or the like) is above a preconfigured threshold; the measured RS-power and/or phase (e.g., RSRP, RSRPP, RSCP, or the like) is outside (or within) a preconfigured threshold range at the configured ToA and/or AoA; the difference between the measured and configured target RS-metric (RSRPP, RSCP, SINR, CIR, or the like) at the configured target ToA and/or AoA is above (or below) a preconfigured threshold; the difference between the measured and configured target RS-metric profile at the configured target ToA and/or AoA is above (or below) a preconfigured threshold; the difference between the measured and configured target profile (e.g., RCS profile) at the configured target ToA and/or AoA is above (or below) a preconfigured threshold; the difference between the measured and configured target Doppler is above (or below) a preconfigured threshold; combinations of the same; or the like.

In one example, the WTRU 102/225 may report the target match and/or mismatch detection likelihood as hard (e.g., true match and/or mismatch like true match detection or target mismatch detection) or soft (e.g., the target match and/or mismatch detection likelihood is expressed as an integer, fraction, ratio, probability, or the like). For example, in an integer number level from 0 to 10, level 0 may indicate target mismatch detection, and level 10 may refer to true match target detection. In another example, 0 may refer to strong target mismatch detection and 10 may refer to strong true match target detection.

In one example, the WTRU 102/225 may determine whether the target and/or EO is unresolvable (or resolvable) based on at least one of the following: the measured uncertainty of the AoA and/or ToA of the reflected RS is above (or below) a preconfigured threshold; the difference between the measured and configured target uncertainty of the AoA and/or ToA of the reflected RS is above (or below) a preconfigured threshold; the detected RS-metric peaks are above (or below) a preconfigured threshold number; the average angular and/or time difference between two measured RS metric peaks within a measurement search window is below (above) a preconfigured threshold; the maximum angular and/or time difference between two measured RS metric peaks within a measurement search window is below (above) a preconfigured threshold; the measured Doppler uncertainty is above (or below) a preconfigured threshold; the difference between the measured and configured target Doppler is above (or below) a preconfigured threshold; the difference between the measured target profile and the configured target profile is above (or below) a preconfigured threshold; combinations of the same; or the like.

In one example, the uncertainty range of the AoA and/or ToA may be determined based on the measured received RS power over a configured threshold within a configured measurement angular and/or time search window. In another example, the uncertainty range of the AoA and/or ToA may be determined based on the number of the detected RS power peaks over (or below) a configured threshold within a configured measurement angular and/or time window.

In one example, the WTRU 102/225 may report a level of target and/or EO resolvability as hard (e.g., resolvable and/or unresolvable like resolvable target and/or EO event, unresolvable target and/or EO event) or soft (e.g., the target and/or EO resolvability may be expressed as an integer number, fraction, ratio, probability or any other level format description). For example, in an integer number level format, the target resolvability may be expressed in numbers 0 to 10, where 0 may indicate unresolvable target and/or EO event and 10 may indicate resolvable target and/or EO event. In another example, the level of target and/or EO resolvability may be described in the form of logical levels like strong unresolvable, weak unresolvable, strong resolvable, or the like.

For example, the WTRU 102/225 may determine the target and/or EO resolvability based on at least one of the following: a number of detected RS metric peaks withing a measurement search window; a minimum and/or average angular and/or time difference between RS metric peaks within a measurement search window; an average measured uncertainty in the AoA and/or ToA of the determined RS metric peaks; combinations of the same; or the like.

In one example, the WTRU 102/225 may determine the association level between each measured RS metric peak within the measurement search window and the configured target profile and/or the configured RS metric profile for the target. In one example, the WTRU 102/225 may report the association between the RS metric peak and the configured target profile and/or RS metric profile for the target as hard (e.g., associated and/or unassociated) or soft (e.g., in the form of an integer number, fraction, ratio, or any other level format.)

In one example, the WTRU 102/225 may be configured with multiple target profiles and/or RS metric profiles that correspond to multiple targets. For example, the WTRU 102/225 may report the association level of each determined RS metric peak to each target profile and/or RS metric profile. In one example, the WTRU 102/225 may determine that an RS metric peak is “unassociated” if the measured RS metric peak profile is unassociated and/or has low association level with, e.g., all the configured profiles of the targets. In one example, the WTRU 102/225 may determine the measured RS metric peak association level with multiple target profiles. In another example, the WTRU 102/225 may determine the measured RS metric peak association level with multiple target profiles and select the target with the highest association level to be associated with the RS metric peak.

In certain representative embodiments, WTRU behavior is provided and/or configured. For example, the WTRU 102/225 can activate RS bandwidth aggregation and measurement search windows based on triggers such as, e.g., event-based, time-based, location-based, mobility-based, QoS-based, and network indicators. Also, for example, the triggers can include mismatch detection events, predefined intervals, geographical proximity, velocity thresholds, and QoS requirements. Further, for example, the WTRU 102/225 may receive network commands to perform RS bandwidth aggregation, which, e.g., involves aggregating frequency resources for refined measurements. In addition, for example, the WTRU 102/225 can switch between different measurement configurations and select subsets of RS resources based on criteria like, e.g., mismatch detection likelihood, location, and velocity. Moreover, for example, the WTRU 102/225 can be configured with multiple subsets of RS resources and select them based on criteria such as, e.g., mismatch detection likelihood, location, and velocity. Furthermore, for example, the WTRU 102/225 can determine the length of the measurement search window based on factors like, e.g., mismatch detection likelihood, location, velocity, and target size. Additionally, for example, the WTRU 102/225 may also activate angle-based and/or time-based measurement search windows based on preconfigured conditions. Still further, for example, the WTRU 102/225 can stop or pause measuring metrics of the RS reflected from the target based on conditions like, e.g., mismatch detection events, resource availability, and task priority. Even further, for example, the WTRU 102/225 can adjust the number and length of aggregated RS resources based on measurement quality, target movement, velocity, target size, and network indications. Yet further, for example, the WTRU 102/225 can also deactivate or reactivate RS bandwidth aggregation and measurement search windows based on similar triggers. Further still, for example, if the WTRU 102/225 terminates measurements, it may report the cause and switch to default or fallback measurement configurations.

In one example, the WTRU 102/225 may be triggered to activate the RS bandwidth aggregation and/or the measurement search window based on at least one of the following: an event-based trigger, a time-based trigger, a location-based trigger, a mobility-based trigger, a QoS-based trigger, an indicator from the NW, combinations of the same, or the like.

For example, regarding the event-based trigger, the WTRU 102/225 may be triggered to activate the RS bandwidth aggregation and/or the measurement search window if a mismatch detection event is detected for the reflected RS from the configured target location. In another example, the WTRU 102/225 may be triggered to activate the RS bandwidth aggregation and/or measurement search window based on the detection of target mismatch detection event for threshold number of measurement occasions. In another example, the WTRU 102/225 may be triggered to activate the RS bandwidth aggregation and/or the measurement search window if a mismatch detection event at a preconfigured level (e.g., strong, weak, medium, or the like) is detected for the reflected RS from the configured target location.

For example, regarding the time-based trigger, the WTRU 102/225 initiates RS bandwidth aggregation and/or a measurement search window at predefined intervals for periodic monitoring. In another example, the WTRU 102/225 may initiate the RS bandwidth aggregation and/or measurement search window if the mismatch target detection event is determined for a preconfigured threshold time and/or for preconfigured number of measurements occasions.

For example, the location-based trigger corresponds to at least one scenario including: when the WTRU 102/225 enters and/or leaves a certain geographical area, when the WTRU 102/225 detects proximity to a particular target or location, when the target enters and/or leaves a certain geographical area, combinations of the same, or the like. In one example, the WTRU 102/225 may be triggered to activate RS bandwidth aggregation and/or a measurement search window if the measured WTRU location (e.g., using radio access technology (RAT)-dependent and/or independent methods, or the like) and the configured target location are below a certain threshold. In another example, the WTRU 102/225 may be triggered to activate RS bandwidth aggregation and/or a measurement search window if the target is located in the proximity of another target and/or EO, or if the difference between the measured target location and the measured location of another target and/or EO is below a preconfigured threshold.

For example, the mobility-based trigger accounts for the WTRU 102/225 and/or target being stationary or mobile. In one example, the WTRU 102/225 may be triggered to activate RS bandwidth aggregation and a measurement search window if the measured WTRU 102/225 and/or target velocity is above a threshold value and/or within a range of threshold values. In another example, the WTRU 102/225 may be triggered to activate RS bandwidth aggregation and a measurement search window if the difference between the measured WTRU velocity and the configured target velocity is above a threshold value.

For example, the QoS-based trigger is based on at least one of sensing accuracy or resolution, positioning-based QoS (e.g., positioning resolution in meters), reliability-based QoS (e.g., missed detection and false alarm percentages), combinations of the same, or the like.

For example, regarding the indicator from the NW, the WTRU 102/225 may receive an activation command of RS bandwidth aggregation (e.g., via DCI, MAC-CE, RRC, LPP message), indicating the WTRU 102/225 to perform RS bandwidth aggregation. Also, for example, the indicator may include information about which frequency resource(s) to aggregate (e.g., frequency layer IDs, bandwidth IDs, ID for a subset of frequency resources, or the like). In one example, the WTRU 102/225 may be configured with periodic search windows. Further, for example, the WTRU 102/225 may receive a request from the network to perform RS bandwidth aggregation. In addition, for example, the request may include measurement configuration at which the WTRU 102/225 should perform RS bandwidth aggregation. Moreover, for example, the WTRU 102/225 may send a response (e.g., ACK, NACK, or the like) for the request received from the network. Furthermore, for example, the measurement configuration can include periodicity of measurement, start and/or end time of measurement, duration of measurement, or the like. Additionally, for example, the WTRU 102/225 may be configured with periodic search window and the periodicity of measurement may be aligned with the periodicity of search window such that the WTRU 102/225 performs RS bandwidth aggregation during the search window. Still further, for example, a start and/or end time may be expressed in terms of absolute time, relative time with respect to a reference, and/or an index of a search window. Even further, for example, if the WTRU 102/225 is configured with more than one search windows, the WTRU 102/225 may receive an indication on which search window the WTRU 102/225 should perform RS bandwidth aggregation. Yet further, for example, the WTRU 102/225 may determine to initiate or activate the RS bandwidth aggregation at N time instances (e.g., N slots, N frames, N subframe) after the WTRU 102/225 receives the indication from the network to perform RS bandwidth aggregation. In one example, if the WTRU 102/225 is configured with a duration (e.g., RS bandwidth aggregation duration) during which the WTRU 102/225 is expected to perform RS bandwidth aggregation, the WTRU 102/225 may determine to perform measurements based on the RS bandwidth aggregation during search window(s) that are activated or configured during the RS bandwidth aggregation duration.

An example of RS bandwidth aggregation is a measurement (e.g., time measurement, power measurement, or the like) based on the aggregated frequency resources (e.g., band, component carrier, frequency layers, bandwidth, bandwidth parts, or the like). By aggregating frequency resources, the WTRU 102/225 may be able to make more refined timing measurements.

In another example, the WTRU 102/225 may be configured with the first measurement configuration (e.g., DL-RS configuration, measurement duration, or the like). For example, the WTRU 102/225 may be configured with the second measurement configuration. Also, for example, the WTRU 102/225 may receive a request to pause the first measurement configuration and activate the second measurement configuration. Further, for example, after the second measurement configuration is deactivated, the WTRU 102/225 may determine to resume measurement based on the first measurement configuration.

For example, the first measurement configuration may contain one bandwidth part or default bandwidth part. Also, for example, the second measurement configuration may contain configurations related to RS bandwidth aggregation, e.g., the WTRU 102/225 can select more than one bandwidth parts for aggregation.

In one example, the WTRU 102/225 may be configured with DL-RS configurations (e.g., bandwidth, frequency layers, or the like), RS resource set ID(s) and/or RS resource ID(s) that are assigned for RS bandwidth aggregation. In one example, the WTRU 102/225 may select a subset S1 of the configured RS resource set ID(s) or RS resource ID(s) for bandwidth aggregation. In one example, the WTRU 102/225 may be configured with more than one subset where, e.g., each subset is associated with an ID. For example, the WTRU 102/225 may be configured with non-overlapping frequency bandwidth BW1, BW2, BW3, and BW4. The subset S1 may consist of BW1 and BW2 while subset S2 may consist of BW3 and BW4. The WTRU 102/225 may determine to select the subset S1 based on a criterion. Also, for example, the WTRU 102/225 may select the subset S1 based on at least one of: a determined target match and/or mismatch detection likelihood by the WTRU 102/225; a configured location of the target and/or the WTRU 102/225; configured velocity of the target and/or the measured WTRU velocity; combinations of the same; or the like.

For example, regarding the determined target match and/or mismatch detection likelihood by the WTRU 102/225, the WTRU 102/225 may select to aggregate a number n1 of the RS resources if the target mismatch detection likelihood is strong mismatch, while it may select to aggregate a number n2<n1 of the RS resources if the target mismatch detection level is weak mismatch. In one example, the WTRU 102/225 may select to aggregate a number n1 of the RS resources that corresponds to a configured time measurement granularity of t1 based on the determined mismatch target detection likelihood. In another example, the WTRU 102/225 may select to aggregate a subset S1 of the RS resources based on the measured RS metric (e.g., RSRP, RSRQ, SINR, or the like) exceeding a threshold value.

For example, regarding the configured location of the target and/or the WTRU 102/225, the WTRU 102/225 may select to aggregate n1 RS resources if the target and/or the WTRU 102/225 enters a specific geographical area. In another example, the WTRU 102/225 may select to aggregate n2 RS resources if the configured target location is determined to be in close proximity with another target and/or EO. In another example, the WTRU 102/225 may select to aggregate n3 RS resources if the number of EOs that are located within a preconfigured threshold distance D1 from the configured target location is m1, while it selects to aggregate n4 RS resources if the number of EOs that are located within a preconfigured threshold distance D2 from the configured target location is m2.

For example, regarding, the configured velocity of the target and/or the measured WTRU velocity, the WTRU 102/225 may aggregate n1 RS resources if the configured target velocity and/or the measured WTRU velocity is v1.

In one example, the WTRU 102/225 may determine to report to the network the subset ID the WTRU 102/225 selected.

In one example, the WTRU 102/225 may determine the length of the measurement search window based on at least one of the following: a determined target match and/or mismatch detection likelihood by the WTRU 102/225; a configured location of the target and/or the measured WTRU location; configured velocity of the target and/or the measured WTRU velocity; target maximum dimension and/or size; combinations of the same; or the like.

For example, regarding the determined target match and/or mismatch detection likelihood by the WTRU 102/225, the WTRU 102/225 may determine that a length L1 (e.g., number of Tc units) of the measurement search window corresponds to target match and/or mismatch detection likelihood y1 (e.g., strong and/or weak and/or medium target mismatch detection or level 0, 1, . . . 10, or the like).

For example, regarding the configured location of the target and/or the measured WTRU location, the WTRU 102/225 may determine a length L2 (e.g., number of Tc units) of the measurement search window that corresponds to configured target location that exists within a specific geographical area y1. In another example, the WTRU 102/225 may determine a length L3 (e.g., number of Tc units) of the measurement search window that corresponds to the presence of the target in close proximity of the configured number of EOs that is equal to y1. In another example, the WTRU 102/225 may determine a length L4 (e.g., number of Tc units) of the measurement search window that corresponds to a difference distance d1 between the configured target location and the closest EO.

For example, regarding the configured velocity of the target and/or the measured WTRU velocity, the WTRU 102/225 may determine that a length L5 (e.g., number of Tc units) of the measurement search window that corresponds to the configured target velocity and/or the measured WTRU velocity is v1.

For example, regarding the target maximum dimension and/or size, the WTRU 102/225 may determine that a length L6 (e.g., number of Tc units) of the measurement search window that corresponds to maximum target size and/or dimension equals to y1.

In one example, the WTRU 102/225 may be triggered to activate an angle-based and/or time-based measurement search window based on the preconfigured triggering conditions. In another example, the WTRU 102/225 may determine the angle-based range (e.g., range of AoAs) for the angle-based measurement search window and/or time-based length (e.g., number of Tc units) for the time-based measurement search window. In another example, the WTRU 102/225 may use the same size for both the angle-based and time-based measurement search window.

In one example, the WTRU 102/225 may be configured to stop measuring the metrics (e.g., RSRP, RSRPP, RSCP, or the like) of the RS that is reflected from the target location (e.g., within specific range of AoA and/or ToA) based on preconfigured triggering conditions. In another example, the WTRU 102/225 may determine to pause the measuring metrics of the RS that is reflected from the target location based on preconfigured triggering conditions. For example, triggering conditions for stopping and/or pausing the measurement of the metrics of the RS reflected from the target may include at least one of the following: the determination of target mismatch detection event for a number of measurement occasions that exceeds a preconfigured threshold; the decrease in the target match and/or mismatch detection likelihood below preconfigured threshold; the determined measurement search window exceeds a preconfigured threshold length; the unavailability of the BW aggregation resources and/or the BW aggregation required resources exceeds a preconfigured threshold; the WTRU 102/225 may have other tasks with higher priority; combinations of the same; or the like.

In one example, the WTRU 102/225 may determine to increase (or decrease) the number of the aggregated RS resources or RS resource sets based on at least one of the configured conditions including: measurement quality, sensing target characteristics, network characteristics, combinations of the same, or the like.

For example, the measurement quality includes the relative or absolute change in target match and/or mismatch detection likelihood. In one example, the WTRU 102/225 may determine to increase (or decrease) number of the aggregated RS resources or RS resource sets by a configured value that corresponds to a decrease (or increase) in the target match and/or mismatch detection likelihood (e.g., the target match and/or mismatch detection likelihood decreased from mismatch detection to strong mismatch detection, or the target match and/or mismatch detection likelihood decrease from level 4 to level 0). In one example, the WTRU 102/225 may determine to increase (or decrease) number of the aggregated RS resources or RS resource sets if the target match and/or mismatch detection likelihood is determined to decrease (or increase) over preconfigured number of measurement occasions. Also, for example, the WTRU 102/225 may determine to decrease the number of the aggregated RS resources or RS resource sets if the determined target match and/or mismatch detection likelihood does not change over preconfigured number of measurement occasions.

For example, the sensing target characteristics includes movement and/or velocity characteristics. Also, for example, the movement characteristics include a change in the measured target and/or WTRU locations. In one example, the WTRU 102/225 may determine to increase (or decrease) a number of the aggregated RS resources or RS resource sets if the number of determined other targets or EO in proximity of the configured target increases (or decreases). In another example, the WTRU 102/225 may determine to decrease the number of the aggregated RS resources or RS resource sets if the measured target location is outside a specific geographical area (e.g., an area with multiple targets or EOs). In another example, the WTRU 102/225 may determine to decrease (or increase) the number of the aggregated RS resources or RS resource sets if the minimum distance between the configured target and closest EO and/or target increases (or decreases). In another example, the WTRU 102/225 may determine to increase (or decrease) the number of the aggregated RS resources or RS resource sets if the distance between the WTRU 102/225 and the configured target increases (or decreases). Regarding the velocity characteristics, the WTRU 102/225 may determine to increase (or decrease) the number of the aggregated RS resources or RS resource sets if the measured target velocity increases (or decreases).

For example, the network characteristics include an indication (implicit or explicit) from the network to increase (or decrease) the number of the aggregated RS resources or RS resource sets.

In one example, the WTRU 102/225 may determine to increase (or decrease) the length of the measurement search window. Also, for example, the WTRU 102/225 may determine to increase (or decrease) the length of the measurement search window based one or more configured conditions described herein.

For example, the one or more configured conditions includes a change in the target match and/or mismatch detection likelihood. Also, for example, the one or more configured conditions includes a change in the measured target and/or WTRU locations. Further, for example, the WTRU 102/225 may determine to increase (or decrease) the length of the measurement search window if the determined number of EOs that are in proximity to the configured target location increases (or decreases). In addition, for example, the WTRU 102/225 may determine to increase (or decrease) the length of the measurement search window if the minimum distance between the configured target and closest EO decreases (or increases). Moreover, for example, the one or more configured conditions includes a change in the measured target velocity. Furthermore, for example, the WTRU 102/225 may determine to increase (or decrease) the length of the measurement search window if the measured target velocity increases (or decreases). Additionally, for example, the one or more configured conditions includes a change in the maximum dimension of the target (e.g., change in the target orientation, posture, or the like). For example, the WTRU 102/225 may determine to increase (or decrease) the length of the measurement search window if the determined maximum target dimension increases (or decreases). Still further, for example, the one or more configured conditions includes an indication from the network to increase (or decrease) the length of the measurement search window.

In one example, the WTRU 102/225 may determine to deactivate and/or reactivate the RS bandwidth aggregation and/or measurement search window based on one or more preconfigured conditions.

For example, the preconfigured condition includes an event-based trigger. In one example, the WTRU 102/225 may be triggered to deactivate (or reactivate) the RS bandwidth aggregation and/or the measurement search window if a true match (or mismatch) detection event is detected for the reflected RS from the configured target location. In another example, the WTRU 102/225 may be triggered to deactivate (or reactivate) the RS bandwidth aggregation and/or measurement search window based on the determination of target true match (or mismatch) detection event for a threshold number of measurement occasions. In another example, the WTRU 102/225 may be triggered to deactivate (or reactivate) the RS bandwidth aggregation and/or the measurement search window if a true match (or mismatch) detection event at a preconfigured level (e.g., strong, weak, medium, or the like) is detected for the reflected RS from the configured target location.

For example, the preconfigured condition includes a time-based trigger. Also, for example, the WTRU 102/225 may periodically check to deactivate or reactivate the RS bandwidth aggregation and/or measurement search window predefined intervals for periodic monitoring.

For example, the preconfigured condition includes a location-based trigger. Also, for example, when the WTRU 102/225 enters and/or leaves a certain geographical area, or when the target enters and/or leaves a certain geographical area. In one example, the WTRU 102/225 may be triggered to deactivate (or reactivate) RS bandwidth aggregation and/or measurement search window if the measured WTRU location (e.g., using radio access technology (RAT)-dependent and/or independent methods) and the configured target location are above a certain threshold. In another example, the WTRU 102/225 may be triggered to deactivate (or reactivate) RS bandwidth aggregation and/or measurement search window if the difference between the measured target location and the measured location of another target and/or EO is above a preconfigured threshold.

For example, the preconfigured condition includes a mobility-based trigger. Also, for example, the mobility-based triggers accounts for the WTRU 102/225 and/or target being stationary or mobile. In one example, the WTRU 102/225 may be triggered to deactivate (or reactivate) RS bandwidth aggregation and measurement search window if the measured WTRU and/or target velocity is below a threshold value and/or within a range of threshold values. In another example, the WTRU 102/225 may be triggered to deactivate (or reactivate) RS bandwidth aggregation and measurement search window if the difference between the measured WTRU velocity and the configured target velocity is below a threshold value.

For example, the preconfigured condition includes a QoS-based trigger. Also, for example, the QoS-based trigger is based on at least one of sensing accuracy or resolution, positioning-based QoS (e.g., positioning resolution in meters), reliability-based QoS (e.g., missed detection and false alarm percentages), combinations of the same, or the like.

For example, the preconfigured condition includes an indicator (e.g., implicit or explicit) from the NW. In one example, the WTRU 102/225 may receive the termination indication via DCI, MAC-CE, RRC or LPP message. For example, the WTRU 102/225 may be configured with semi-persistent measurement. Also, for example, the WTRU 102/225 may determine to perform RS bandwidth aggregation during a configured time window. Further, for example, after the window, the WTRU 102/225 may determine to terminate the RS bandwidth aggregation. In another example, the WTRU 102/225 may be configured with start and/or end time which indicates the duration during which the WTRU 102/225 may perform RS bandwidth aggregation. In one example, the termination indication may indicate that the WTRU 102/225 shall terminate RS bandwidth aggregation. In another example, the termination indication may indicate that the indicated search window(s) is deactivated.

In one example, the WTRU 102/225 measures the RS metric (e.g., RSRPP, RSCP, SINR, or the like) within the measurement search window based on the configured and determines the RS metric angle-based and/or time-based profile based within the measurement search window. Also, for example, for the RS metric time-based profile, the WTRU 102/225 may use the RS path delay and/or ToA measurement configuration to determine the ToA of the RS resource. In one example, the WTRU 102/225 may determine the RS metric peak in the RS metric profile based on the configured criteria from the network.

In one example, if the WTRU 102/225 determines to terminate or deactivate measurements (e.g., based on RS bandwidth aggregation) and/or reporting, the WTRU 102/225 may report the cause of the deactivation or termination (e.g., no change in measurement, target match and/or mismatch). Also, for example, the content of the cause may include any of the examples described herein.

In another example, if the WTRU 102/225 determines to deactivate the RS bandwidth aggregation, the WTRU 102/225 may determine to perform the default or fallback measurement using the default or fallback measurement configuration (e.g., based on active BWP, active BW).

In certain representative embodiments, WTRU reporting is provided and/or configured. For example, the WTRU 102/225 performs target sensing tasks and sends measurement reports periodically, aperiodically, or semi-persistently over an uplink channel. Also, for example, the reports include true match detection, mismatch detection, and RS bandwidth aggregation information. Further, for example, the WTRU 102/225 can send these reports over uplink channels based on the report type and event trigger, using short formats for non-aggregated RS bandwidth and long formats for aggregated bandwidth. In addition, for example, reports can also be sent via PUSCH with configured scheduling. Moreover, for example, the WTRU 102/225 may send decoding information for these reports, and the gNB may blind-decode them. Furthermore, for example, reporting periodicity can be based on event type, likelihood of detection, or bandwidth aggregation status. Additionally, for example, different measurement types, such as, e.g., soft or hard indicators, are used depending on RS bandwidth aggregation status, with varying granularity. Still further, for example, the WTRU 102/225 can be configured with different timing granularities for RS bandwidth aggregation, selecting and reporting the appropriate granularity when activated. Even further, for example, the WTRU 102/225 can report the ToA of signals relative to a reference time and is configured to report a maximum number of paths or EOs when RS bandwidth aggregation is active.

In one example, the WTRU 102/225 performs target sensing task measurements and sends a target sensing task measurement report in periodic, aperiodic, or semi-persistent from over an uplink control or data channel.

In one example, the WTRU 102/225 may determine an event of true match target detection. For example, the WTRU 102/225 sends a target sensing task measurement report R1. Also, for example, the target sensing task measurement report R1 contains at least one of the following: a target true match detection indication; a target true match detection indication level (e.g., logical levels such as: strong, medium, weak, or the like, numeric level such as 0 to 10, or the like); measured target parameters (e.g., RCS); measured RS parameters (e.g., RSRPP, RSCP, or the like); the difference between measured and configured target parameters; the difference between measured and configured RS parameters; combinations of the same; or the like.

In one example, the WTRU 102/225 may determine an event of target mismatch detection. For example, the WTRU 102/225 sends a target sensing task measurement report R2 that may contain at least one of the following: a target mismatch detection indication; a target mismatch detection indication level (e.g., logical levels such as: strong, medium, weak, or the like, numeric level such as 0 to 10, or the like); measured RS parameters (e.g., RSRPP, RSCP, or the like); the difference between measured and configured target parameters; the difference between measured and configured RS parameters; the criteria used to determine the target mismatch detection; the recommended RS bandwidth aggregation (e.g., number of resource sets and/or resources required for bandwidth aggregation, time granularity required for measurement); a time granularity for the measurement report; the recommended length of the measurement search window; combinations of the same; or the like. Also, for example, the time granularity for the measurement report may be in accordance with the following: number N1 of T_{c}, where T_{c} is a basic timing unit defined in formula (1), as follows:

$${T}_{c} = 1 / ( Δ {f}_{max} \cdot {N}_{f} ) Δ {f}_{max} = 480 \times 1 {0}^{3} , \qquad ( 1 )$$

where N_{f}=4096, or the like.

In one example, the WTRU 102/225 may be triggered to activate the RS bandwidth aggregation and/or measurement search window. For example, the WTRU 102/225 sends a target sensing task measurement report R3 that may contain at least one of the following: BW aggregation information (e.g., number of BW aggregated, frequency bands, selected RS resource sets or resource ID(s) for bandwidth aggregation, or the like); a time granularity for measurement report (e.g., in accordance with the variables and formula (1) above); the configured reference for measuring the RS path delay and/or ToA; a measurement search window (e.g., length of the window, type, method used to calculate, start time of the window, or the like); a resolvable and/or unresolvable target and/or EO indication; measured RS parameters (e.g., RSRPP, RSCP, or the like); an unresolved target and/or EO information; a resolved target and/or EO information; combinations of the same; or the like.

For example, the configured reference for measuring the RS path delay and/or ToA includes: the path timing used for determining RSTD or WTRU Rx-Tx time difference; or the ToA and/or path delay of the RS that is reflected from a reference target (e.g., tree, building, or the like); or the ToA and/or path delay of first path; or the ToA and/or path delay of LoS path.

For example, the unresolved target and/or EO information may include at least one of: target and/or EO resolvability level; detected RS-metric peaks information (e.g., number, corresponding AoA, ToA for each peak, difference from configured target peak location, or the like); RS-metric peak detection criteria; measured uncertainty in ToA and/or AoA and/or Doppler within the measurement search window; a difference between the measured and configured target uncertainty in ToA and/or AoA and/or Doppler; combinations of the same; or the like.

For example, the resolved target and/or EO information may include at least one of: target and/or EO resolvability level; RS-metric peaks association indication with the Target and/or EO (e.g., peak 1 is associated to target, and peaks 2,3,4 are associated to EO); RS-metric peak detection criteria; RS metric peaks association level; measured target parameters (e.g., RCS); the difference between measured and configured target parameters; the difference between measured and configured RS parameters; measured EO parameters (e.g., RCS); a number of resolved EOs; a type of resolved EOs; combinations of the same; or the like.

In one example, the WTRU 102/225 may send the sensing measurement reports R1, R2, and R3 over any configured uplink control or data channel. In another example, the WTRU 102/225 may be configured to send each report (e.g., R1, R2, R3, or the like) on preconfigured uplink control or data channel based on the report type and/or triggering event type (e.g., R3 can be sent over PUSCH, while R1 and R2 over PUCCH).

In one solution, for the sensing measurement report that is associated with non-aggregated RS bandwidth, the report may be transmitted over PUCCH and/or Uplink Control Information (UCI) short format (e.g., formats 0, 2). In another solution, for the sensing measurement report that is associated with aggregated RS bandwidth and/or measurement search window, the report may be transmitted over PUCCH and/or UCI long format (e.g., formats 1, 3, 4). For example, the sensing measurement report may be transmitted over certain UL resources based on the corresponding payload size. Also, for example, long format PUCCH may be used for more granular reporting (and vice versa).

In one solution, the measurement report may be transmitted through PUSCH, e.g., via RRC and/or MAC-CE through a configured scheduling mechanism (configured grant).

In one example, the WTRU 102/225 may be configured to send decoding information (e.g., report format, type of content, allocated fields for each measurement, or the like) for the sensing measurement report on specific uplink control or data channel (e.g., the WTRU 102/225 may send the decoding information of the report associated with RS bandwidth aggregation on the PUCCH). In another example, the gNB may blind-decode the received measurement sensing report from the WTRU 102/225. In one example, the WTRU 102/225 may be configured to send a report to the network on a specific uplink control or data channel based on the measurement time granularity and/or aggregated bandwidth.

In another example, the WTRU 102/225 may be configured to send the report to the network on a specific uplink control or data channel based on the report periodicity type (e.g., periodic, aperiodic, semi-persistent, or the like).

In one example, the WTRU 102/225 may determine an event of target mismatch detection and/or unresolvable target and/or EO detection and report to the network in a periodic, aperiodic, or semi-persistent form. In one example, the WTRU 102/225 may be configured with specific reporting periodicity that is associated to the determined event (e.g., target mismatch detection, unresolvable target and/or EO event, or the like). In another example, the WTRU 102/225 may be configured with reporting periodicity that is associated to the likelihood of target match and/or mismatch detection and/or the level of target and/or EO resolvability. In another example, the WTRU 102/225 may be configured with a specific reporting periodicity that is associated to the aggregated RS bandwidth and/or the measurement search window length.

In another example, the WTRU 102/225 may be configured to report a first measurement type if RS bandwidth aggregation is activated. For example, the WTRU 102/225 may be configured to report the second measurement type if RS bandwidth aggregation is deactivated. An example of the first measurement type may be the likelihood of detection or misdetection of the target using a soft indicator. An example of the second measurement type is the likelihood of detection or misdetection of the target using a hard indicator. Also, for example, granularity of the indicator between the first and second measurement type may be different. Further, for example, both the first and second measurement types may be indicators of detection or misdetection of the target. In the example, granularity of the first measurement type may be finer than the second measurement type (e.g., the first measurement type has a granularity of 0.01 while the second measurement type has granularity of 0.1).

In one example, the WTRU 102/225 may be configured with a granularity of measurement (e.g., on the order of N nanoseconds) that is associated with RS bandwidth aggregation. For example, the granularity may be associated with the number of aggregated frequency resources. For example, the WTRU 102/225 may be configured with a first and second timing measurement granularity which is associated with first and second aggregation configuration (e.g., number of frequency layers to aggregate for measurement), respectively. In another example, the WTRU 102/225 may be configured with more than one timing granularities and the WTRU 102/225 may select one of the granularities when RS bandwidth aggregation is activated. Also, for example, the WTRU 102/225 may report the selected timing granularity.

In one example, the WTRU 102/225 may report ToA of DL-RS or ToA of a path with respect to a reference time. Also, for example, the reference time may be the ToA of the first path, or configured time such as the beginning of the subframe, SFN, first SFN, or the like.

In one example, the WTRU 102/225 may be configured with the measurement configuration (e.g., maximum number of paths and/or EOs to report) when the RS bandwidth aggregation is activated or configured. For example, the WTRU 102/225 may be configured to report up to N paths or N EOs when RS bandwidth aggregation is activated.

In certain representative embodiments, one or more WTRU reporting updates arc provided and/or configured. For example, the WTRU 102/225 performs measurements on RS reflected from a target location and may determine that the target sensing task measurement report is invalid or outdated, e.g., based on changes in target detection, resolvability, aggregated RS bandwidth, measurement search window, RS-metric peaks, RS metrics, and differences between configured and measured profiles. Also, for example, based on these changes, the WTRU 102/225 sends an updated report containing updated parameters, such as, e.g., target detection indication, measured target parameters, RS metrics, and measurement search window information. Further, for example, the WTRU 102/225 may report the invalidity of a previous measurement report to the network.

In one example, the WTRU 102/225 may perform measurements on the RS reflected from the target location over multiple measurement occasions. For example, the WTRU 102/225 may determine that the target sensing task measurement report may be invalid or outdated.

For example, the WTRU 102/225 may determine that the target sensing task measurement report may be invalid or outdated based on at least one of: the change in target match and/or mismatch detection event may be a hard change (e.g., true match target detection to target mismatch detection and vice versa) or a soft change (e.g., change in the target match and/or mismatch detection likelihood as the logic (e.g., strong, weak, medium, or the like) or numeric (0, 1, . . . 10) or any other level format); the change in the detected target and/or EO resolvability that may be a hard change (e.g., resolvable target and/or EO detection to unresolvable target and/or EO detection and vice versa) or a soft change (e.g., change in the target and/or EO resolvability level expressed as logical levels, numerical levels, or any other level format); the change in the aggregated RS bandwidth (e.g., the change in the number of the aggregated RS resources over a preconfigured threshold value, the change in the resource sets and/or resource set ID(s) that are assigned for bandwidth aggregation, or the like); the change in the measurement search window (e.g., the change in the length of the measurement search window over preconfigured threshold value, the change in the type of the measurement search window (e.g., angle and/or time-based), the change in the start time index of the measurement search window, or the like); the change in the activation and/or deactivation status of the measurement search window and/or the aggregated RS bandwidth; the change in the detected RS-metric peaks within the measurement search window (e.g., the change in the number, magnitude, phase, separation between peaks in time and/or angle, or the like) over a preconfigured threshold value; the change in the measured RS metrics and/or metric profile over a preconfigured threshold; the change in the difference between the configured and measured RS metric and/or metric profile over a preconfigured threshold; the change in the difference between the configured and measured target profile over a preconfigured threshold; combinations of the same; or the like.

In a solution, based on any of the above, the WTRU 102/225 determines to send an updated target sensing task measurement report in aperiodic, periodic, or semi-persistent form over an UL control or data channel. For example, the updated target sensing task measurement report contains at least one of the following: updated target mismatch and/or true match detection indication; updated target mismatch and/or true match detection level; updated measured target parameters (e.g., RCS); updated measured RS metrics (e.g., RSRPP, RSCP, SINR, or the like); updated difference between measured and configured target profile and/or RS metric profile; updated BW aggregation information; updated measurement search window information; updated resolved and/or unresolved target and/or EO indication; updated unresolved target and/or EO information; updated resolved target and/or EO information; combinations of the same; or the like.

In another example, the WTRU 102/225 may be configured to report the invalidity of a previous target sensing task measurement report to the network.

In certain representative embodiments, WTRU reporting termination is provided and/or configured. For example, the WTRU 102/225 can terminate reporting target sensing measurements based on several conditions, such as, e.g., the detection event likelihood falling below a threshold, no change in target match/mismatch detection, no change in target/EO resolvability, limited change in aggregated RS bandwidth, limited change in the measurement search window, limited change in detected RS-metric peaks, changes in measured RS metrics or profiles below thresholds, and network termination indication. Also, for example, upon determining termination, the WTRU 102/225 sends a report with a termination indicator, timestamp, and detailed reason. Further, for example, the WTRU 102/225 includes the latest sensing target task measurement report, e.g., which contains all requested information such as, e.g., RS metrics used for target match/mismatch detection, matched target profile indices, and RS signal ID used for detection.

For example, the WTRU 102/225 is configured to perform the measurements over multiple occasions (e.g., multi-slot level with a repetition factor, time gap configurations, or the like). Also, for example, the WTRU 102/225 determines that reporting the target sensing measurements that are linked to the presence of the target in close proximity of the EO can be terminated. Further, for example, the WTRU 102/225 determines that the reporting the target sensing measurements that are linked to the presence of the target in the close proximity of the EO can be terminated based on at least one of the following: the determination of target mismatch detection event and/or the event likelihood falls below a preconfigured threshold for a configured threshold time or configured number of measurement occasions; the determination of no change in the target match and/or mismatch detection that may be hard change (e.g., true match target detection to target mismatch detection and vice versa) or soft change (e.g., change in the target match and/or mismatch detection likelihood as the logic (e.g., strong, weak, medium, or the like) or numeric (0, 1, . . . 10) or any other level format); the determination of no change in the detected target and/or EO resolvability that may be hard change (e.g., resolvable target and/or EO detection to unresolvable target and/or EO detection and vice versa) or soft change (e.g., change in the target and/or EO resolvability level expressed as logical levels, numerical levels, or any other level format); no change and/or limited change in the aggregated RS bandwidth (e.g., the change in the number of the aggregated RS resources below a preconfigured threshold value, no change in the resource sets and/or resource set ID(s) that are assigned for bandwidth aggregation, or the like); no change and/or limited change in the measurement search window (e.g., the change in the length of the measurement search window below preconfigured threshold value, no change in the type of the measurement search window (e.g., angle and/or time-based), no change in the start time index of the measurement search window, or the like); no change and/or limited change in the detected RS-metric peaks within the measurement search window (e.g., the change in the number, magnitude, phase, separation between peaks in time and/or angle, or the like) below a preconfigured threshold value; the change in the measured RS metric and/or metric profile is below a preconfigured threshold; the change in the difference between the configured and measured RS metric and/or metric profile is below a preconfigured threshold; the change in the difference between the configured and measured target profile is below a preconfigured threshold; a termination indication by the network.

In one example, the WTRU 102/225 may receive the termination indication via a DCI, MAC-CE, RRC or LPP message.

In one example, the WTRU 102/225 may start a prohibit reporting procedure on the mismatch detection event and/or the event likelihood falls below a preconfigured threshold, where a timer and/or counter is used to terminate reporting after reaching a corresponding configured maximum time or maximum count.

In a solution, based on any of the above, the WTRU 102/225 determines to send a report over a UL control or data channel containing the recommendation to terminate the measurement procedure. Also, for example, the WTRU 102/225 determines to send the report over the UL control or the data channel containing the recommendation to terminate the measurement procedure and at least one of the following: a termination indicator; a termination time stamp; a detailed termination reason; the latest sensing target task measurement report including all requested information such as one or more of the RS metrics used for the target match and/or mismatch detection measurement, one or more of the matched target profile indices, RS signal ID used for detection, or the like; combinations of the same; or the like.

In one example, the termination indicator may refer to the reason of termination. For example, termination indicator=1 refers to the change in any aggregated bandwidth and/or measurement search window is below a configured (or preconfigured) threshold for N measurement occasions. Also, for example, an indicator value=2 refers to the allocation of WTRU resources to other higher priority tasks.

For example, the detailed termination reason includes the change in the length of the measurement search window, or the number of RS resources that assigned for bandwidth aggregation over N measurement occasions. In another example, the WTRU 102/225 may report to the network the other higher priority tasks and the priority order of the sensing target in a close proximity of one or more EOs.

In certain representative embodiments, one or more methods for sensing in the presence of EOs are provided. For example, the WTRU 102/225 receives configurations from the NW for target sensing, including thresholds to detect unresolvable targets, and performs measurements based on RS. Also, for example, the WTRU 102/225 detects one or more target mismatch events by comparing RS measurements with the configured target profile at specific AoAs and ToAs, activates bandwidth aggregation within a preconfigured measurement search window, and reports details of detected targets and EOs to the NW. Further, for example, the WTRU 102/225 determines mismatch (or true match) detection events based on differences between measured and configured target RS-metrics (e.g., RSRPP, RSCP, SINR, CIR) at the configured ToA and/or AoA, if these differences exceed preconfigured thresholds. In addition, for example, the WTRU 102/225 aggregates RS bandwidth to measure reflected RS within a measurement search window, sends measurement sensing reports to the NW with time granularity based on triggered events, and the NW decodes these reports using reported WTRU decoding information or blind decoding criteria.

For example, the WTRU 102/225 receives the configuration from the NW for target sensing including thresholds to detect when a sensing target is unresolvable. Also, for example, the WTRU 102/225 receives from the NW sensing target assistance information. Further, for example, the WTRU 102/225 receives the RS reflected from the target location and performs sensing measurements based on the received RS. In addition, for example, the WTRU 102/225 determines the “target mismatch detection” event based on comparison between RS measurement and configured target profile at the configured AoA and/or ToA. Moreover, for example, the WTRU 102/225 activates the bandwidth aggregation within a measurement search window, where the length of the search window is preconfigured by the NW. Furthermore, for example, the WTRU 102/225 sends a report to the NW that may contain details on the triggered event, detected resolvable and/or unresolvable target and/or EO within the measurement search window.

FIG. 3 is an exemplary figure of a solution according to one or more embodiments. FIG. 3 shows a RS received power-delay curve, i.e., normalized received (Rx) power over time (T_{c}). Curve 305 represents the RS received power in the presence of a target object (TO) only. Curve 310 represents the RS received power in the presence of an EO and the TO. The RS power-delay curve 305 has a peak value P₁ at a specific ToA T1. The RS power-delay curve 310 has peak values at P₂ and P₃ at ToA T2 and T3, respectively. The WTRU 102/225 determines a target mismatch detection. For example, the WTRU 102/225 determines the target mismatch detection by comparing the configured value of P₁ in the curve 305 to a corresponding value on the curve 340 at ToA T1. For example, based on determining the target mismatch detection, the WTRU 102/225 activates, e.g., more granular measurement through RS bandwidth aggregation within a measurement (search) window 320. The parameters of the measurement (search) window 320 and RS bandwidth aggregation are preconfigured by the NW.

Uncertainty of ToA may be expressed, for example, according to Option 1 or Option 2. For Option 1, the uncertainty of ToA corresponds with a time 325 from P₁ at T1 to P₃ at T3. For Option 2, the uncertainty of ToA corresponds with a time 330 from two points, i.e., a first intersection of the curve 310 with a received power threshold 315 at a normalized Rx power of 0.4, which occurs at time=about 104, and a second intersection of the curve 310 with the received power threshold 315 at the normalized Rx power of 0.4, which occurs at time=about 123.

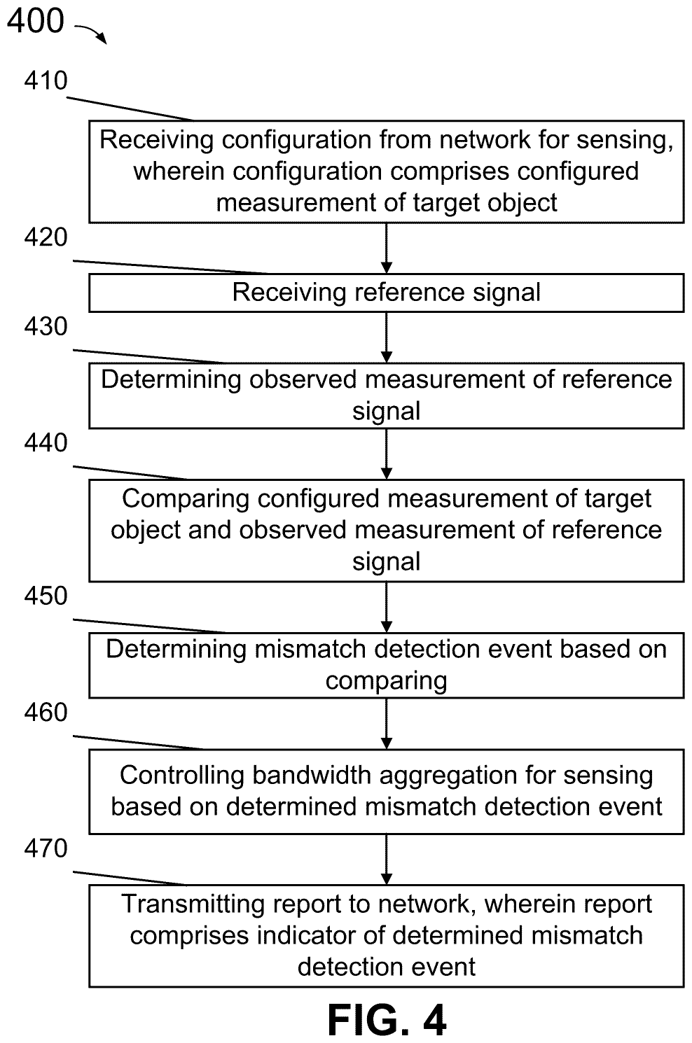

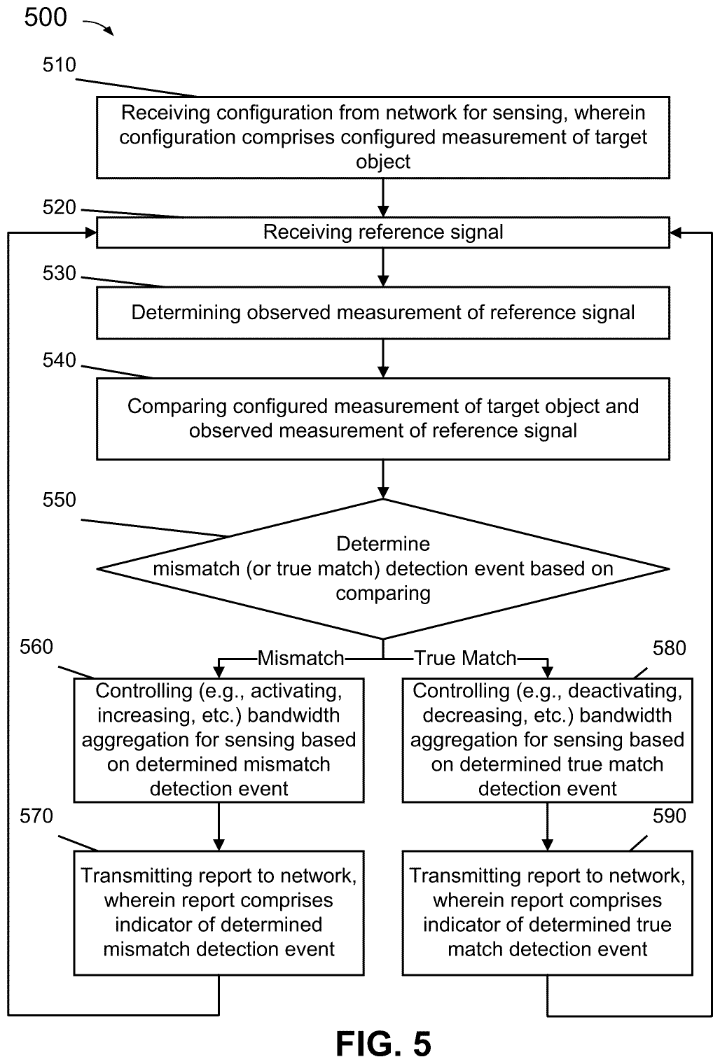

In certain representative embodiments, as shown in FIGS. 4 and 5, a method 400/500 performed by a wireless transmit/receive unit (WTRU) 102/225 is provided for a sensing task. For example, the method 400/500 includes receiving 410/510 a configuration from a network 115 for sensing. Examples of the WTRU 102/225 are described above, e.g., in descriptions of WTRU behavior. Examples of the configuration are described above, e.g., in descriptions of one or more configurations and sensing assistance information.

Also, for example, the configuration comprises a configured measurement of a target object 210. Further, for example, the method 400/500 comprises receiving 420/520 a reference signal. In addition, for example, the method 400/500 comprises determining 430/540 an observed measurement of the reference signal. Moreover, for example, the method 400/500 comprises comparing 440/540 the configured measurement of the target object 210 and the observed measurement of the reference signal. Furthermore, for example, the method 400/500 comprises determining 450/550 a mismatch detection event based on the comparing. Additionally, for example, the method 400/500 comprises controlling 460/560 bandwidth aggregation for sensing based on the determined mismatch detection event. Still further, for example, the method 400/500 comprises transmitting 470/570 a report to the network. Even further, for example, the report comprises an indicator of the determined mismatch detection event. Examples of the measurements are described above, e.g., in descriptions of sensing measurement events and sensing measurement events triggers. Examples of the mismatch detection event are described above, e.g., in descriptions of sensing measurement events. Examples of the reports are described above, e.g., in descriptions of WTRU reporting, WTRU reporting updates, and WTRU reporting termination.

For example, the configuration comprises a bandwidth aggregation configuration comprising one or more triggers for at least one of activating, deactivating, increasing, or decreasing the bandwidth aggregation. Also, for example, the controlling the bandwidth aggregation for sensing comprises the at least one of the activating, the deactivating, the increasing, or the decreasing the bandwidth aggregation. Further, for example, the controlling the bandwidth aggregation for sensing is further based on the one or more triggers. In addition, for example, the one or more triggers (for the bandwidth aggregation) comprises at least one of an event-based trigger, a time-based trigger, a location-based trigger, a mobility-based trigger, or a quality of service-based trigger. Moreover, for example, the report comprises information of a recommended reference signal bandwidth aggregation. Examples of the triggers are described above, e.g., in descriptions of sensing measurement events triggers.

For example, the configuration comprises a measurement search window configuration specifying a measurement search window comprising one or more triggers for at least one of activating, deactivating, length increasing, or length decreasing the measurement search window. Also, for example, the comparing the configured measurement of the target object 210 and the observed measurement of the reference signal comprises measuring the reference signal within the measurement search window specified in the measurement search window configuration. Further, for example, the method 400/500 comprises utilizing the bandwidth aggregation within the measurement search window based on the determined mismatch detection event. In addition, for example, the one or more triggers (for the measurement search window) comprises at least one of an event-based trigger, a time-based trigger, a location-based trigger, a mobility-based trigger, or a quality of service-based trigger. Moreover, for example, the report comprises information of a recommended length of the measurement search window.

For example, the comparing the configured measurement of the target object 210 and the observed measurement of the reference signal comprises determining a difference between the configured measurement of the target object 210 and the observed measurement of the reference signal at a configured target time of arrival or a configured target angle of arrival. Also, for example, the comparing the configured measurement of the target object 210 and the observed measurement of the reference signal comprises comparing the difference to a preconfigured threshold. Further, for example, each of the configured measurement of the target object 210 and the observed measurement of the reference signal is at least one of a reference signal received power per path, a reference signal carrier phase, a signal to interference noise ratio, a carrier to interference ratio, or a reference signal profile.

For example, the method 500 comprises receiving a subsequent reference signal, e.g., between steps 570 and 520. Also, for example, the method 500 comprises determining a subsequent observed measurement of the subsequent reference signal. Further, for example, the method 500 comprises comparing the configured measurement of the target object 210 and the subsequent observed measurement of the subsequent reference signal. In addition, for example, the method 500 comprises determining 580 a true match detection event based on the comparing. Moreover, for example, the method 500 comprises deactivating 580 bandwidth aggregation for sensing based on the determined true match detection event. Furthermore, for example, the method 500 comprises transmitting 590 a subsequent report to the network. Additionally, for example, the subsequent report comprises an indicator of the determined true match detection event. Examples of the true match detection event are described above, e.g., in descriptions of sensing measurement events.

In certain representative embodiments, a wireless transmit/receive unit (WTRU) 102/225 for a sensing task is provided. For example, the WTRU 102/225 comprises a processor 118. Also, for example, the WTRU 102/225 comprises a transceiver 120 coupled to the processor 118. Further, for example, the WTRU 102/225 is to receive a configuration from a network 115 for sensing. In addition, for example, the configuration comprises a configured measurement of a target object 210. Moreover, for example, the WTRU 102/225 is to receive a reference signal. Furthermore, for example, the WTRU 102/225 is to determine an observed measurement of the reference signal. Additionally, for example, the WTRU 102/225 is to compare the configured measurement of the target object 210 and the observed measurement of the reference signal. Still further, for example, the WTRU 102/225 is to determine a mismatch detection event based on the comparing. Even further, for example, the WTRU 102/225 is to control bandwidth aggregation for sensing based on the determined mismatch detection event. Yet further, for example, the WTRU 102/225 is to transmit a report to the network. Further still, for example, the report comprises an indicator of the determined mismatch detection event. The detailed examples relating to the method 400/500 also apply to the WTRU 102/225 as described herein.

For example, the configuration comprises a bandwidth aggregation configuration comprising one or more triggers for at least one of activating, deactivating, increasing, or decreasing the bandwidth aggregation. Also, for example, the controlling the bandwidth aggregation for sensing comprises the at least one of the activating, the deactivating, the increasing, or the decreasing the bandwidth aggregation. Further, for example, the controlling the bandwidth aggregation for sensing is further based on the one or more triggers. In addition, for example, the one or more triggers (for the bandwidth aggregation) comprises at least one of an event-based trigger, a time-based trigger, a location-based trigger, a mobility-based trigger, or a quality of service-based trigger. Moreover, for example, the report comprises information of a recommended reference signal bandwidth aggregation.

For example, the configuration comprises a measurement search window configuration specifying a measurement search window comprising one or more triggers for at least one of activating, deactivating, length increasing, or length decreasing the measurement search window. Also, for example, the WTRU 102/225 to compare the configured measurement of the target object 210 and the observed measurement of the reference signal is to measure the reference signal within the measurement search window specified in the measurement search window configuration. Further, for example, the WTRU 102/225 is to utilize the bandwidth aggregation within the measurement search window based on the determined mismatch detection event. In addition, for example, the one or more triggers (for the measurement search window) comprises at least one of an event-based trigger, a time-based trigger, a location-based trigger, a mobility-based trigger, or a quality of service-based trigger. Moreover, for example, the configuration comprises information of a recommended length of the measurement search window.

For example, the WTRU 102/225 to compare the configured measurement of the target object 210 and the observed measurement of the reference signal is to determine a difference between the configured measurement of the target object 210 and the observed measurement of the reference signal at a configured target time of arrival or a configured target angle of arrival. Also, for example, the WTRU 102/225 to compare the configured measurement of the target object 210 and the observed measurement of the reference signal is to compare the difference to a preconfigured threshold. Further, for example, each of the configured measurement of the target object 210 and the observed measurement of the reference signal is at least one of a reference signal received power per path, a reference signal carrier phase, a signal to interference noise ratio, a carrier to interference ratio, or a reference signal profile.

For example, the WTRU 102/225 is to receive a subsequent reference signal. Also, for example, the WTRU 102/225 is to determine a subsequent observed measurement of the subsequent reference signal. Further, for example, the WTRU 102/225 is to compare the configured measurement of the target object 210 and the subsequent observed measurement of the subsequent reference signal. In addition, for example, the WTRU 102/225 is to determine a true match detection event based on the comparing. Moreover, for example, the WTRU 102/225 is to deactivate bandwidth aggregation for sensing based on the determined true match detection event. Furthermore, for example, the WTRU 102/225 is to transmit a subsequent report to the network, the subsequent report comprising an indicator of the determined true match detection event.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving a configuration from a network for sensing, wherein the configuration comprises a configured measurement of a target object;
receiving a reference signal;
determining an observed measurement of the reference signal;
comparing the configured measurement of the target object and the observed measurement of the reference signal;
determining a mismatch detection event based on the comparing;
controlling bandwidth aggregation for sensing based on the determined mismatch detection event; and
transmitting a report to the network, the report comprising an indicator of the determined mismatch detection event.

2. The method of claim 1, wherein:
the configuration comprises a bandwidth aggregation configuration comprising one or more triggers for at least one of activating, deactivating, increasing, or decreasing the bandwidth aggregation;
the controlling the bandwidth aggregation for sensing comprises the at least one of the activating, the deactivating, the increasing, or the decreasing the bandwidth aggregation; and
the controlling the bandwidth aggregation for sensing is further based on the one or more triggers.

3. The method of claim 2, wherein the one or more triggers comprises at least one of an event-based trigger, a time-based trigger, a location-based trigger, a mobility-based trigger, or a quality of service-based trigger.

4. The method of claim 2, wherein the report comprises information of a recommended reference signal bandwidth aggregation.

5. The method of claim 1, wherein:
the configuration comprises a measurement search window configuration specifying a measurement search window comprising one or more triggers for at least one of activating, deactivating, length increasing, or length decreasing the measurement search window;
the comparing the configured measurement of the target object and the observed measurement of the reference signal comprises measuring the reference signal within the measurement search window specified in the measurement search window configuration; and
the method comprises utilizing the bandwidth aggregation within the measurement search window based on the determined mismatch detection event.

6. The method of claim 5, wherein the one or more triggers comprises at least one of an event-based trigger, a time-based trigger, a location-based trigger, a mobility-based trigger, or a quality of service-based trigger.

7. The method of claim 5, wherein the report comprises information of a recommended length of the measurement search window.

8. The method of claim 1 wherein the comparing the configured measurement of the target object and the observed measurement of the reference signal comprises:
determining a difference between the configured measurement of the target object and the observed measurement of the reference signal at a configured target time of arrival or a configured target angle of arrival; and
comparing the difference to a preconfigured threshold.

9. The method of claim 8, wherein each of the configured measurement of the target object and the observed measurement of the reference signal is at least one of a reference signal received power per path, a reference signal carrier phase, a signal to interference noise ratio, a carrier to interference ratio, or a reference signal profile.

10. The method of claim 1, comprising:
receiving a subsequent reference signal;
determining a subsequent observed measurement of the subsequent reference signal;
comparing the configured measurement of the target object and the subsequent observed measurement of the subsequent reference signal;
determining a true match detection event based on the comparing;
deactivating bandwidth aggregation for sensing based on the determined true match detection event; and
transmitting a subsequent report to the network, the subsequent report comprising an indicator of the determined true match detection event.

11. A wireless transmit/receive unit (WTRU) comprising:
a processor; and
a transceiver coupled to the processor, wherein the WTRU is to:
receive a configuration from a network for sensing, wherein the configuration comprises a configured measurement of a target object;
receive a reference signal;
determine an observed measurement of the reference signal;
compare the configured measurement of the target object and the observed measurement of the reference signal;
determine a mismatch detection event based on the comparing;
control bandwidth aggregation for sensing based on the determined mismatch detection event; and
transmit a report to the network, the report comprising an indicator of the determined mismatch detection event.

12. The WTRU of claim 11, wherein:
the configuration comprises a bandwidth aggregation configuration comprising one or more triggers for at least one of activating, deactivating, increasing, or decreasing the bandwidth aggregation;
the controlling the bandwidth aggregation for sensing comprises the at least one of the activating, the deactivating, the increasing, or the decreasing the bandwidth aggregation; and
the controlling the bandwidth aggregation for sensing is further based on the one or more triggers.

13. The WTRU of claim 12, wherein the one or more triggers comprises at least one of an event-based trigger, a time-based trigger, a location-based trigger, a mobility-based trigger, or a quality of service-based trigger.

14. The WTRU of claim 12, wherein the report comprises information of a recommended reference signal bandwidth aggregation.

15. The WTRU of claim 11, wherein:
the configuration comprises a measurement search window configuration specifying a measurement search window comprising one or more triggers for at least one of activating, deactivating, length increasing, or length decreasing the measurement search window;
the WTRU to compare the configured measurement of the target object and the observed measurement of the reference signal is to measure the reference signal within the measurement search window specified in the measurement search window configuration; and
the WTRU is to utilize the bandwidth aggregation within the measurement search window based on the determined mismatch detection event.

16. The WTRU of claim 15, wherein the one or more triggers comprises at least one of an event-based trigger, a time-based trigger, a location-based trigger, a mobility-based trigger, or a quality of service-based trigger.

17. The WTRU of claim 15, wherein the configuration comprises information of a recommended length of the measurement search window.

18. The WTRU of claim 11 wherein the WTRU to compare the configured measurement of the target object and the observed measurement of the reference signal is to:
determine a difference between the configured measurement of the target object and the observed measurement of the reference signal at a configured target time of arrival or a configured target angle of arrival; and
compare the difference to a preconfigured threshold.

19. The WTRU of claim 18, wherein each of the configured measurement of the target object and the observed measurement of the reference signal is at least one of a reference signal received power per path, a reference signal carrier phase, a signal to interference noise ratio, a carrier to interference ratio, or a reference signal profile.

20. The WTRU of claim 11, wherein the WTRU is to:
receive a subsequent reference signal;
determine a subsequent observed measurement of the subsequent reference signal;
compare the configured measurement of the target object and the subsequent observed measurement of the subsequent reference signal;
determine a true match detection event based on the comparing;
deactivate bandwidth aggregation for sensing based on the determined true match detection event; and
transmit a subsequent report to the network, the subsequent report comprising an indicator of the determined true match detection event.
